(19) United States
(12) Patent Application Publication
(10) Pub. No.: US 2019/0161598 A1
(43) Pub. Date: May 30, 2019

(54) PLASTICIZER COMPOSITION

(71) Applicant: BASF SE, Ludwigshafen am Rhein (DE)

(72) Inventors: Matthias PFEIFFER, Ludwigshafen am Rhein (DE); Boris BREITSCHEIDEL, Ludwigshafen am Rhein (DE); Axel GRIMM, Ludwigshafen am Rhein (DE); Herbert MORGENSTERN, Ludwigshafen am Rhein (DE)

(21) Appl. No.: 16/321,936

(22) PCT Filed: Jul. 27, 2017
(86) PCT No.: PCT/EP2017/068984

§ 371 Date: Jan. 30, 2019

(30) Foreign Application Priority Data
Aug. 1, 2016 (EP) 16182123.6

(51) Int. Cl. C08K 5/12; C08L 27/06

(52) U.S. Cl. CPC C08K 5/12; C08K 2201/014; C08L 2203/16; C08L 27/06

(57) ABSTRACT

A plasticizer composition comprising
(a) at least one compound of the general formula (I),

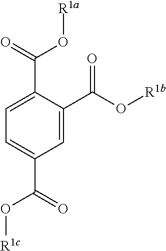

in which
R^{1a}, R^{1b} and R^{1c} are each independently C₃ to C₅-alkyl
(b) at least one compound of the general formula (II),

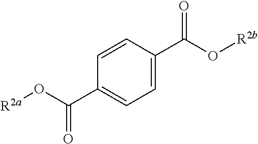

in which
R^{2a} and R^{2b} are each independently C₈-alkyl.

### BACKGROUND OF THE INVENTION

The present invention relates to a plasticizer composition comprising at least one trialkyl trimellitate and at least one dioctyl terephthalate, to molding compositions comprising at least one polymer and one such plasticizer composition, to plastisols comprising at least one polymer and one such plasticizer composition and to the use of these plasticizer compositions, molding compositions and plastisols.

### PRIOR ART

Polyvinyl chloride (PVC), in terms of amount, is one the most commonly produced plastics. PVC is usually a hard and brittle plastic up to ca. 80° C., which is used as unplasticized PVC (PVC-U) by adding thermal stabilizers and other additives. By adding plasticizers, plasticized PVC (PVC-P) can be made, which may be used for many applications for which unplasticized PVC is un-suitable.

In general, the use of plasticizers serves to lower the processing temperature of plastics and to increase the elasticity thereof.

Plasticizers are typically used in other plastics besides PVC. Other plastics can be, for example, polyvinyl butyral (PVB), homo- or copolymers of styrene, polyacrylates, polysulfides or thermoplastic polyurethanes (TPU).

Typical plasticizers for plastics are, for example, ortho-phthalic acid esters such as di-2-ethylhexyl phthalate, diisononyl phthalate or diisodecyl phthalate. However, short-chain ortho-phthalic acid esters increasingly cause difficulties due to their toxicological properties.

It is desirable that the plasticizers, in addition to a high compatibility with the plastic to be plasticized, that is to say they do not leak out of the plastic to be plasticized, or only relatively slowly, are largely of no toxicological concern.

A plasticizer, largely of no toxicological concern, which has gained a certain industrial rele-vance, especially for PVC, is di-2-ethylhexyl terephthalate (DENT or also DOTP).

The object of the present invention, therefore, is to provide a plasticizer composition for plastics, for PVC for example, based on DOTP, which has a high compatibility with the plastics to be plasticized and is not of toxicological concern. In addition, the plasticizer composition should also impart good mechanical properties to the plasticizers plasticized therewith and exhibit a low volatility both in terms of processing and during use.

This object is achieved by a plasticizer composition comprising

(a) at least one compound of the general formula (I),

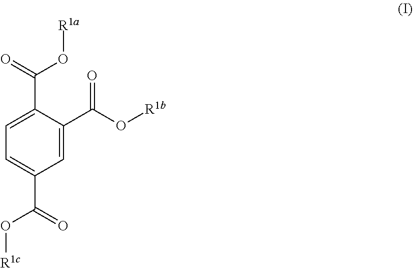

in which

R^{1a}, R^{1b} and R^{1c} are each independently C₃ to C₅-alkyl

(b) at least one compound of the general formula (II),

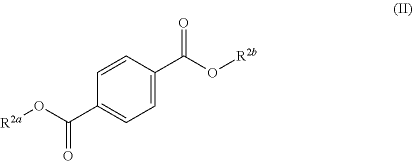

in which

R^{2a} and R^{2b} are each independently C₈-alkyl,

A subject matter of the disclosure is the use of the disclosed plasticizer composition as plasticizer for plastics.

Also a subject matter of the disclosure is the use of the disclosed plasticizer composition as plasticizer for plastisols.

A subject matter of the disclosure is likewise a molding composition comprising at least one polymer and the disclosed plasticizer composition.

Furthermore, a subject matter of the disclosure is a plastisol comprising at least one polymer and the disclosed plasticizer composition.

A subject matter of the present disclosure is also the use of a molding composition comprising at least one polymer and the disclosed plasticizer composition for producing moldings and films.

A subject matter of the present disclosure is also the use of a plastisol comprising at least one polymer and the disclosed plasticizer composition for producing moldings and films.

Moldings and films comprising the disclosed plasticizer composition are also a subject matter of the present disclosure.

### DESCRIPTION OF THE INVENTION

In the context of the present disclosure, the abbreviation phr (parts per hundred resin) stands for parts by weight per hundred parts by weight polymer.

The percentage by weight figures, unless stated to the contrary, refer to the respective total weight.

A mixture is any desired mixture of two or more, for example a mixture may comprise two to five or more. A mixture may also comprise any large number.

In the context of the present disclosure, a gellating aid is a plasticizer or a mixture of different plasticizers, which is characterized in that the dissolution temperature of the plasticizer or the mixture of different plasticizers is at most 125° C., in accordance with DIN 53408 (June 1967).

A compound of the general formula (I) can be:

I.1 is tri(n-propyl) 1,2,4-benzenetricarboxylate
I.2 is tri(isopropyl) 1,2,4-benzenetricarboxylate
I.3 is tri(n-butyl) 1,2,4-benzenetricarboxylate
I.4 is tri(isobutyl) 1,2,4-benzenetricarboxylate
I.5 is tri(n-pentyl) 1,2,4-benzenetricarboxylate
I.6 is tri(2-methylbutyl) 1,2,4-benzenetricarboxylate
I.7 is tri(3-methylbutyl) 1,2,4-benzenetricarboxylate

A compound of the general formula (II) can be:

II.1 is di(2-ethylhexyl) terephthalate
II.2 is di(n-octyl) terephthalate

A polymer can be an elastomer or a thermoplastic. A thermoplastic is generally thermoplastical-ly processable.

A thermoplastic can be, for example:

TP.1 is a homo- or copolymer which comprises, in polymerized form, at least one monomer selected from C₂ to C₁₀ monoolefins, for example ethene, propylene, 1,3-butadiene, 2-chloro-1,3-butadiene, vinyl alcohols or C₂- to C₁₀-alkyl esters thereof, vinyl acetate, vinyl chloride, vinylidene chloride, vinylidene fluoride, tetrafluoroethylene, glycidyl acrylate, glycidyl methacrylate, acrylates or methacrylates with alcohol components of branched or unbranched C₁ to C₁₀-alcohols, vinylaromatics, for example styrene, (meth)acrylonitrile, α,β-ethylenically unsaturated mono- or dicarboxylic acids, and maleic anhydride.
TP.2 is a polyvinyl ester
TP.3 is a polycarbonate
TP.4 is a polyether
TP.5 is a polyether ketone
TP.6 is a thermoplastic polyurethane
TP.7 is a polysulfide
TP.8 is a polysulfone
TP.9 is a polyester
TP.10 is a polyalkylene terephthalate
TP.11 is a polyhydroxyalkanoate
TP.12 is a polybutylene succinate
TP.13 is a polybutylene succinate adipate
TP.14 is a polyacrylate having the same or different alcohol residues from the group of C₄- to C₈-alcohols such as butanol, hexanol, octanol, or 2-ethylhexanol
TP.15 is a polymethyl methacrylate
TP.16 is a methyl methacrylate-butyl acrylate copolymer
TP.17 is an acrylonitrile-butadiene-styrene copolymer
TP.18 is an ethylene-propylene copolymer
TP.19 is an ethylene-propylene-diene copolymer
TP.20 is a polystyrene
TP.21 is a styrene-acrylonitrile copolymer
TP.22 is an acrylonitrile-styrene-acrylate
TP.23 is a styrene-butadiene-methyl methacrylate copolymer
TP.24 is a styrene-maleic anhydride copolymer
TP.25 is a styrene-methacrylic acid copolymer
TP.26 is a polyoxymethylene
TP.27 is a polyvinyl alcohol
TP.28 is a polyvinyl acetate
TP.29 is a polyvinyl butyral
TP.30 is a polyvinyl chloride
TP.31 is a polycaprolactone
TP.32 is polyhydroxybutyric acid
TP.33 is polyhydroxyvaleric acid
TP.34 is polylactic acid
TP.35 is ethylcellulose
TP.36 is cellulose acetate
TP.37 is cellulose propionate
TP.38 is cellulose acetate/butyrate

“X” as entry in a table means that this combination is present.

In general, polyvinyl chloride is obtained by homopolymerization of vinyl chloride. The polyvinyl chloride present in the disclosed molding composition can be produced, for example, by suspension polymerization or bulk polymerization. The polyvinyl chloride present in the disclosed plastisol can be produced, for example, by microsuspension polymerization or bulk polymerize-tion. The preparation of polyvinyl chloride by polymerization of vinyl chloride and production and composition of plasticized polyvinyl chloride are described, for example, in “Becker/Braun, Kun-ststoff-Handbuch [Plastics Handbook], Volume 2/1: Polyvinylchloride”, 2nd edition, Carl Hanser Verlag, Munich.

The K value, which characterizes the molar mass of the polyvinyl chloride and is determined in accordance with DIN EN 1628-2 (November 1999), for the polyvinyl chloride plasticized with the disclosed plasticizer composition is usually in the range from 57 to 90, preferably in the range from 61 to 85 and particularly preferably in the range from 64 to 80.

Advantageously, the present plasticizer composition is characterized by a high compatibility with the plastic to be plasticized. In addition, the gelling characteristics of the plastics plasticized therewith can be positively influenced by the present plasticizer composition. Furthermore, the present plasticizer composition can be characterized by low volatility, both during processing and during use of the end products. Likewise, the present plasticizer composition can have an advantageous effect on the mechanical properties of the plastics plasticized therewith.

Good mechanical properties can be reflected, for example, in high elasticity of the plasticized plastics. A measure of elasticity of plasticized plastics is the Shore A hardness. The lower the Shore A hardness, the higher the elasticity of the plasticized plastics.

A measure of good gelling properties can be a low dissolution temperature and/or a low gelling temperature.

The compatibility (permanence) of plasticizers in plasticized plastics characterizes to which extent plasticizers tend to bleed during use of the plasticized plastics and as a result of which the use properties of the plastics are impaired.

Low volatility during processing can be reflected, for example, by low process volatility.

Low volatility during use of the end product can be reflected, for example, by low film volatility.

Compounds of the general formula (I) have a comparable or lower dissolution temperature than bis(2-ethylhexyl) phthalate (125° C.) in accordance with DIN 53408 (June 1967). Owing to their dissolution temperature and their plasticizer properties, compounds of the general formula (I) can be used as gellating aids.

In general, the dissolution temperature/gelling temperature refers to the minimum temperature at which a substantially homogeneous phase between polymer and plasticizer is formed.

The subject matter of the present disclosure is a plasticizer composition comprising at least one compound of the general formula (I) and at least one compound of the general formula (II).

In a compound of the general formula (I), R^{1a}, R^{1b} and R^{1c} are each independently C₃- to C₅-alkyl. C₃- to C₅-alkyl can be straight-chain or branched. For example, C₃- to C₅-alkyl can be n-propyl, isopropyl, n-butyl, isobutyl, n-pentyl, 2-methylbutyl or 3-methylbutyl. It may be more preferable that R^{1a}, R^{1b} and R^{1c} are each independently C₄-alkyl. C₄-alkyl can be straight-chain or branched. For example, C₄-alkyl can be n-butyl or isobutyl.

Even if R^{1a}, R^{1b} and R^{1c} in a compound of the general formula (I) are generally independent of each other, R^{1a}, R^{1b} and R^{1c} are generally identical.

The plasticizer composition disclosed comprises at least one compound of the general formula (I). The plasticizer composition disclosed can accordingly also comprise a mixture of compounds of the general formula (I).

The plasticizer composition may comprise, for example, a mixture of compounds of the general formula (I), selected from I.1, I.2, I.3, I.4, I.5, I.6 and I.7.

In a compound of the general formula (II), R^{2a} and R^{2b} are each independently C₈-alkyl. C₈-alkyl can be straight-chain or branched. For example, C₈-alkyl can be n-octyl, isooctyl, or 2-ethylhexyl,

Even if R^{2a} and R^{2b} in a compound of the general formula (II) are generally independent of each other, R^{2a} and R^{2b} are generally identical.

The plasticizer composition disclosed comprises at least one compound of the general formula (II). The plasticizer composition disclosed can accordingly also comprise a mixture of corn-pounds of the general formula (II).

The plasticizer composition disclosed may comprise, for example, a mixture of compounds of the general formula (II), selected from II.1 and II.2.

A plasticizer composition may comprise, for example:

Dialkyl terephthalate

| Trialkyl trimellitate | II.1 | II.2 |
|---|---|---|
| I.1 | X | |
| I.1 | | X |
| I.1 | X | X |
| I.2 | X | |
| I.2 | | X |
| I.2 | X | X |
| I.3 | X | |
| I.3 | | X |
| I.3 | X | X |
| I.4 | X | |
| I.4 | | X |
| I.4 | X | X |
| I.5 | X | |
| I.5 | | X |
| I.5 | X | X |
| I.6 | X | |
| I.6 | | X |
| I.6 | X | X |
| I.7 | X | |
| I.7 | | X |
| I.7 | X | X |

a mixture of compounds I.1 to I.7 and compound II.1
or,
a mixture of compounds I.1 to I.7 and compound II.2
or,
a mixture selected from compound I.1, I.2, I.3, I.4, I.5, I.6 and I.7 and a mixture selected from compound II.1 and II.2.

The content of at least one compound of the general formula (I) in the plasticizer composition disclosed is generally 5 to 70 percent by weight. It may be preferable that the content is 8 to 70 percent by weight and more preferably 10 to 70 percent by weight. The content of at least one compound of the general formula (I) in the plasticizer composition disclosed can be, for example, 15, 20, 25, 30, 35, 40, 45, 50, 55, 60, or 65 percent by weight.

The content of at least one compound of the general formula (II) in the plasticizer composition disclosed is generally 30 to 95 percent by weight. It may be preferable that the content is 30 to 92 percent by weight and more preferably 30 to 90 percent by weight. The content of at least one compound of the general formula (II) in the plasticizer composition disclosed can be, for example, 35, 40, 45, 50, 55, 60, 65, 70, 75, 80, or 85 percent by weight.

The subject matter of the disclosure can therefore be a plasticizer composition comprising 5 to 70 percent by weight of at least one compound of the general formula (I) and comprising 30 to 95 percent by weight of at least one compound of the general formula (II). It may be preferable that a plasticizer composition comprises 8 to 70 percent by weight of at least one compound of the general formula (I) and 30 to 92 percent by weight of at least one compound of the general formula (II). It may be more preferable that a plasticizer composition comprises 10 to 70 percent by weight of at least one compound of the general formula (I) and 30 to 90 percent by weight of at least one compound of the general formula (II).

In the context of the disclosure, a plasticizer composition can comprise,

Dialkyl terephthalate
30 to 95% by weight of

| Trialkyl trimellitate | II.1 | II.2 |
|---|---|---|
| 5 to 70% by weight of I.1 | X | |
| 5 to 70% by weight of I.1 | | X |
| 5 to 70% by weight of I.1 | X | X |
| 5 to 70% by weight of I.2 | X | |
| 5 to 70% by weight of I.2 | | X |
| 5 to 70% by weight of I.2 | X | X |
| 5 to 70% by weight of I.3 | X | |
| 5 to 70% by weight of I.3 | | X |
| 5 to 70% by weight of I.3 | X | X |
| 5 to 70% by weight of I.4 | X | |
| 5 to 70% by weight of I.4 | | X |
| 5 to 70% by weight of I.4 | X | X |
| 5 to 70% by weight of I.5 | X | |
| 5 to 70% by weight of I.5 | | X |
| 5 to 70% by weight of I.5 | X | X |
| 5 to 70% by weight of I.6 | X | |
| 5 to 70% by weight of I.6 | | X |
| 5 to 70% by weight of I.6 | X | X |
| 5 to 70% by weight of I.7 | X | |
| 5 to 70% by weight of I.7 | | X |
| 5 to 70% by weight of I.7 | X | X |

5 to 70 percent by weight of a mixture of compounds I.1 to I.7 and 30 to 95 percent by weight of compound II.1
or,
5 to 70 percent by weight of a mixture of compounds I.1 to I.7 and 30 to 95 percent by weight of compound II.2
or,
5 to 70 percent by weight of a mixture selected from compound I.1, I.2, I.3, I.4, I.5, I.6 and I.7 and 30 to 95 percent by weight of a mixture selected from compound II.1 and II.2.

In the plasticizer composition disclosed, the weight ratio of the at least one compound of the general formula (I) and the at least one compound of the general formula (II) can be in the range from 1:19 to 7:3. It may be preferable that the weight ratio is in the range from 1:11.5 to 7:3. It may be further preferable that the weight ratio is in the range from 1:9 to 7:3. For instance, the weight ratio of at least one compound of the general formula (I) and at least one compound of the general formula (II) can be in the range from 1:15, 1:5, 1:1, or 2:1.

A plasticizer composition, in addition to at least one compound of the general formula (I) and (II), can comprise at least one plasticizer which is different to the compounds of the general formula (I) and (II).

A plasticizer which is different to the compounds of the general formula (I) or (II) can be, for example, a dialkyl terephthalate having 4 to 7 carbon atoms in the alkyl chains, a dialkyl terephthalate having 9 to 13 carbon atoms in the alkyl chains, a dialkyl phthalate, a dialkyl cyclohexane-1,2-dicarboxylate having 4 to 13 carbon atoms in the alkyl chains, a dialkyl cyclohexane-1,3-dicarboxylate, a dialkyl cyclohexane-1,4-dicarboxylate, a dialkyl malate, a dialkyl acetylmalate, an alkyl benzoate, a dibenzoic acid ester, a saturated alkyl monocarboxylate, an unsaturated monocarboxylate, a saturated dicarboxylic acid diester, an unsaturated dicarboxylic acid diester, an aromatic sulfonic acid ester, an alkylsulfonic acid ester, a glycerol ester, an isosorbide ester, a phosphoric acid ester, a citric acid triester, an acylated citric acid triester, an alkylpyrrolidone derivative, a dialkyl 2,5-furandicarboxylate, a dialkyl 2,5-tetrahydrofurandicarboxylate, a polyester of aliphatic and/or aromatic polycarboxylic acids having at least dihydric alcohols, an epoxidized vegetable oil or an epoxidized fatty acid monoalkyl ester.

A dialkyl terephthalate, which is different to the compound of the general formula (II), generally comprises 4 to 7 carbon atoms in the alkyl chains. The alkyl chains of the dialkyl terephthalates different to the compound of the general formula (II) may each independently have a different number of carbon atoms.

A dialkyl terephthalate, which is different to the compound of the general formula (II), generally comprises 9 to 13 carbon atoms in the alkyl chains. The alkyl chains of the dialkyl terephthalates different to the compound of the general formula (II) may each independently have a different number of carbon atoms. A dialkyl terephthalate, which is different to the compound of the general formula (II), may be diisononyl terephthalate for example.

A dialkyl phthalate may comprise 9 to 13 carbon atoms in the alkyl chains. The alkyl chains may each independently comprise a different number of carbon atoms. A dialkyl phthalate can be, for example, diisononyl phthalate.

A dialkyl cyclohexane-1,2-dicarboxylate generally comprises 4 to 13 carbon atoms in the alkyl chains. The alkyl chains of the dialkyl cyclohexane-1,2-dicarboxylate may each independently comprise a different number of carbon atoms. A dialkyl cyclohexane-1,2-dicarboxylate can be, for example, di(2-isononyl) 1,2-cyclohexanedicarboxylate, such as Hexamoll®DINCH®.

A dialkyl cyclohexane-1,3-dicarboxylate may comprise 4 to 13 carbon atoms in the alkyl chains. The alkyl chains of the dialkyl cyclohexane-1,3-dicarboxylate may each independently comprise a different number of carbon atoms.

A dialkyl cyclohexane-1,4-dicarboxylate may comprise 4 to 13 carbon atoms in the alkyl chains. The alkyl chains of the dialkyl cyclohexane-1,4-dicarboxylate may each independently comprise a different number of carbon atoms. A dialkyl cyclohexane-1,4-dicarboxylate may be, for example, di(2-ethylhexyl) cyclohexane-1,4-dicarboxylate.

A dialkyl malate or a dialkyl acetylmalate may comprise 4 to 13 carbon atoms in the alkyl chains. The alkyl chains of the dialkyl malate or dialkyl acetylmalate may each independently comprise a different number of carbon atoms.

An alkyl benzoate may comprise 7 to 13 carbon atoms in the alkyl chain. An alkyl benzoate can be, for example, isononyl benzoate, isodecyl benzoate, or 2-propylheptyl benzoate.

A dibenzoic acid ester can be, for example, diethylene glycol dibenzoate, dipropylene glycol dibenzoate, tripropylene glycol dibenzoate, or dibutylene glycol dibenzoate.

A saturated monocarboxylic ester can be, for example, an ester of acetic acid, an ester of butyric acid, an ester of valeric acid, or an ester of lactic acid. A saturated monocarboxylic ester can also be an ester of a monocarboxylic acid with a polyvalent alcohol. For instance, pentaerythritol can be fully esterified with valeric acid.

An unsaturated monocarboxylic ester can be, for example, an ester of acrylic acid.

An unsaturated dicarboxylic diester can be, for example, an ester of fumaric acid.

An alkylsulfonic ester may comprise 8 to 22 carbon atoms in the alkyl chain. An alkylsulphonic ester may be, for example, a phenyl or cresyl ester of pentadecylsulfonic acid.

An isosorbide ester is generally an isosorbide diester which has been esterified with C₈- to C₁₃-carboxylic acids. An isosorbide diester may comprise different or identical C₈- to C₁₃-alkyl chains.

A phosphoric ester can be tri-2-ethylhexyl phosphate, trioctyl phosphate, triphenyl phosphate, isodecyl diphenyl phosphate, or bis-2(2-ethylhexyl) phenyl phosphate, 2-ethylhexyl diphenyl phosphate.

In a citric acid triester, the OH group may be present in free or carboxylated form, for example acetylated form. The alkyl chains of the citric acid triester or the acetylated citric acid triester each independently comprise 4 to 8 carbon atoms.

An alkylpyrrolidone derivative may comprise 4 to 18 carbon atoms in the alkyl chain.

A dialkyl 2,5-furandicarboxylate may comprise 5 to 13 carbon atoms in the alkyl chains. The alkyl chains of the dialkyl 2,5-furandicarboxylate may each independently comprise a different number of carbon atoms.

A dialkyl 2,5-tetrahydrofurandicarboxylate may comprise 5 to 13 carbon atoms in the alkyl chains. The alkyl chains of the dialkyl 2,5-tetrahydrofurandicarboxylate may each independently comprise a different number of carbon atoms.

A polyester having aromatic or aliphatic polycarboxylic acids can be a polyester based on adipic acid with polyhydric alcohols, such as dialkylene glycol adipates having 2 to 6 carbon atoms in the alkylene unit. Examples can be polyester adipates, polyglycol adipates and polyester phthalates.

If in the plasticizer composition disclosed at least one plasticizer is present which is different from that of the compound of the general formula (I) and (II), the content thereof in the plasticizer composition disclosed is up to 50 percent by weight, based on the total amount of all plasticizers present in the plasticizer composition. It may be preferable that the content in the plasticizer composition disclosed is up to 40 percent by weight. It may be further preferable that the content in the plasticizer composition disclosed is up to 25 percent by weight.

In general, however, it may be preferable that no plasticizer different to the compounds of the general formula (I) and (II) is present in the plasticizer composition disclosed.

A subject matter of the disclosure is likewise a molding composition comprising the disclosed plasticizer composition and at least one polymer.

The molding composition disclosed may accordingly also comprise a mixture of polymers.

In the molding composition comprising the disclosed plasticizer composition, at least one thermoplastic is usually present. The molding composition disclosed may accordingly also comprise a mixture of thermoplastics.

A molding composition may comprise, for example

| | Trialkyl trimellitate and | |
|---|---|---|
| | dialkyl terephthalate | |
| Thermoplastic | I.3 and II.1 | I.3 and II.2 |
| TP 30 | X | |
| TP 30 | | X |
| TP 30 | X | X |
| TP 29 | X | |
| TP 29 | | X |
| TP 29 | X | X |
| Homo- and/or copolymers of vinyl acetate | X | |
| Homo- and/or copolymers of vinyl acetate | | X |
| Homo- and/or copolymers of vinyl acetate | X | X |
| Homo- and/or copolymers of styrene | X | |
| Homo- and/or copolymers of styrene | | X |
| Homo- and/or copolymers of styrene | X | X |
| TP14 | X | |
| TP14 | | X |
| TP14 | X | X |
| TP 6 | X | |
| TP 6 | | X |
| TP 6 | X | X |
| TP 7 | X | |
| TP 7 | | X |
| TP 7 | X | X |
| | Trialkyl trimellitate and | |
| | dialkyl terephthalate | |
| Thermoplastic | I.4 and II.1 | I.4 and II.2 |
| TP 30 | X | |
| TP 30 | | X |
| TP 30 | X | X |
| TP 29 | X | |
| TP 29 | | X |
| TP 29 | X | X |
| Homo- and/or copolymers of vinyl acetate | X | |
| Homo- and/or copolymers of vinyl acetate | | X |
| Homo- and/or copolymers of vinyl acetate | X | X |
| Homo- and/or copolymers of styrene | X | |
| Homo- and/or copolymers of styrene | | X |
| Homo- and/or copolymers of styrene | X | X |
| TP14 | X | |
| TP14 | | X |
| TP14 | X | X |
| TP 6 | X | |
| TP 6 | | X |
| TP 6 | X | X |
| TP 7 | X | |
| TP 7 | | X |
| TP 7 | X | X |

Depending on the polymer which is present in the molding composition disclosed, it may be that, in order to achieve the desired thermoplastic properties, various amounts of the disclosed plasticizer composition have to be present in the molding composition disclosed. Adjustment of the desired thermoplastic properties of the disclosed molding composition is generally a matter of routine to a person skilled in the art.

If no polyvinyl chloride is present in the molding composition disclosed, the amount of plasticizer composition disclosed in the molding composition disclosed is generally 0.5 to 300 phr. It may be preferable that the amount of disclosed plasticizer composition in the molding composition disclosed is I.0 to 130 phr. It may be further preferable that the amount of disclosed plasticizer composition in the molding composition is 2.0 to 100 phr. The amount of plasticizer composition disclosed which is present in the molding composition disclosed can be, for example, 5, 10, 15, 20, 25, 30, 35, 40, 45, 50, 55, 60, 65, 70, 75, 80, 85, 90 or 95 phr.

If polyvinyl chloride is present in the molding composition, the amount of plasticizer composition disclosed in the molding composition disclosed is generally 5 to 300 phr. It may be preferable that the amount of disclosed plasticizer composition in the molding composition disclosed is 15 to 200 phr. It may be further preferable that the amount of disclosed plasticizer composition in the molding composition disclosed is 30 to 150 phr. The amount of plasticizer composition disclosed which is present in the molding composition disclosed can be, for example, 35, 40, 45, 50, 55, 60, 65, 70, 75, 80, 85, 90, 95, 100, 105, 110, 115, 120, 125, 130, 135, 140, or 145 phr.

As a rule, the molding composition disclosed comprises 20 to 90 percent by weight polyvinyl chloride. It may be preferable that the molding composition comprises 40 to 90 percent by weight polyvinylchloride and more preferably 45 to 85 percent by weight. For example, the molding composition disclosed may comprise 50, 55, 60, 65, 70, 75 or 80 percent by weight polyvinyl chloride.

The molding composition disclosed comprising at least one thermoplastic and the disclosed plasticizer composition may also comprise further additives. Likewise, the plastisol disclosed comprising at least one thermoplastic and the disclosed plasticizer composition may also comprise further additives. Additives can be, for example, stabilizers, lubricants, fillers, colorants, flame retardants, light stabilizers, blowing agents, polymeric processing agents, impact modifiers, optical brighteners, antistatic agents, biostabilizers or a mixture thereof.

The additives described hereinafter do not limit the disclosed molding composition or the disclosed plastisol, but rather serve only for elucidating the disclosed molding composition or disclosed plastisol.

Stabilizers can be the customary polyvinyl chloride stabilizers in solid and liquid form such as Ca/Zn, Ba/Zn, Pb, Sn stabilizers, acid-binding sheet silicates, carbonates such as hydrotalcite or mixtures thereof.

The molding composition disclosed or the plastisol disclosed may comprise a content of stabilizers of 0.05 to 7 percent by weight, based on the total weight of the molding composition or plastisol. It may be preferable that the content of stabilizers is 0.1 to 5 percent by weight and more preferably 0.5 to 3 percent by weight.

As a rule, lubricants serve to reduce the adhesion between the disclosed molding composition or the disclosed plastisol and surfaces, and should lower, for example, the friction forces on mixing, plastification or shaping.

Lubricants used in the disclosed molding composition or in the disclosed plastisol can be all lubricants commonly used in plastics processing. Common lubricants in plastics processing are, for example, hydrocarbons such as oils, paraffins, PE waxes or mixtures thereof, fatty alcohols having 6 to 20 carbon atoms, ketones, carboxylic acids such as fatty acids, montanic acids or mixtures thereof, oxidized PE waxes, metal salts of carboxylic acids, carboxamides, carboxylic esters which result from esterification of alcohols such as ethanol, fatty alcohols, glycerol, ethanediol or pentaerythritol with long-chain carboxylic acids.

The molding composition disclosed or the plastisol disclosed may comprise a content of lubricants of 0.01 to 10 percent by weight, based on the total weight of the molding composition or plastisol. It may be preferable that the content of lubricants is 0.05 to 5 percent by weight and more preferably 0.2 to 2 percent by weight.

Fillers are generally used to positively influence the compressive strength, tensile strength and/or flexural strength, the hardness and/or heat distortion temperature, of the disclosed molding composition or disclosed plastisol.

The fillers that may be present in the disclosed molding composition or disclosed plastisol can be, for example, carbon black and/or inorganic fillers. Inorganic fillers may be natural calcium carbonates such as chalk, limestone, marble, synthetic calcium carbonates, dolomite, silicates, silica, sand, diatomaceous earth, aluminum silicates such as kaolin, mica, feldspar or any desired mixture of two or more of the fillers mentioned above.

The molding composition disclosed or the plastisol disclosed may comprise a content of fillers of 0.01 to 80 percent by weight, based on the total weight of the molding composition or plastisol. It may be preferable that the content of fillers is 0.01 to 60 percent by weight and more preferably 1 to 40 percent by weight. For instance, the molding composition disclosed or the plastisol disclosed may comprise a content of fillers of 2, 5, 8, 10, 12, 15, 18, 20, 22, 25, 27, 30, 33, 36 or 39 percent by weight.

Colorants can serve to adjust the disclosed molding composition or the disclosed plastisol to different possible applications. Colorants can be, for example, pigments and/or dyes.

The pigments that may be present in the disclosed molding composition or disclosed plastisol can be, for example, inorganic and/or organic pigments. Inorganic pigments can be cobalt pigments such as CoO/Al₂O₃ and/or chromium pigments such as Cr₂O₃. Organic pigments can be monoazo pigments, condensed azo pigments, azomethine pigments, anthraquinone pigments, quinacridones, phthalocyanine pigments and/or dioxazine pigments.

The molding composition disclosed or the plastisol disclosed may comprise a content of colorants of 0.01 to 10 percent by weight, based on the total weight of the molding composition or plastisol. It may be preferable that the content of colorants is 0.05 to 5 percent by weight and more preferably 0.1 to 3 percent by weight.

Flame retardants can serve to reduce the flammability of the disclosed molding composition or the disclosed plastisol and smoke formation in the case of combustion.

Flame retardants which can be present in the disclosed molding composition or disclosed plastisol can be, for example, antimony trioxide, chloroparaffin, phosphate esters, aluminum hydroxide and/or boron compounds.

The molding composition disclosed or the plastisol disclosed may comprise a content of flame retardants of 0.01 to 10 percent by weight, based on the total weight of the molding composition or plastisol. It may be preferable that the content of flame retardants is 0.2 to 5 percent by weight and more preferably 0.5 to 2 percent by weight.

Light stabilizers such as UV absorbers can serve to protect the molding composition disclosed or the plastisol disclosed from damage due to the influence of light.

Light stabilizers can be, for example, hydroxybenzophenones, hydroxyphenylbenzotriazoles, cyanoacrylates, “hindered amine light stabilizers” such as derivatives of 2,2,6,6-tetramethylpiperidine or mixtures of the compounds mentioned above.

The molding composition disclosed or the plastisol disclosed may comprise a content of light stabilizers of 0.01 to 7 percent by weight, based on the total weight of the molding composition or plastisol. It may be preferable that the content of light stabilizers is 0.02 to 4 percent by weight and more preferably 0.5 to 3 percent by weight.

The plasticizer composition disclosed and at least one elastomer can also be present in the molding composition disclosed.

Accordingly, the plasticizer composition disclosed and a mixture of elastomers may also be present in the molding composition disclosed.

An elastomer can be, for example, a rubber. A rubber can be a natural rubber or a rubber produced by a synthetic route.

Rubber produced by a synthetic route can be, for example, polyisoprene rubber, styrene-butadiene rubber, butadiene rubber, nitrile-butadiene rubber, chloroprene rubber.

As a rule, the molding composition disclosed comprises at least natural rubber and/or at least one synthetic rubber in which the rubber or rubber mixture present can be vulcanized with sulfur.

The molding composition disclosed usually comprises at least one elastomer at a proportion of 20 to 95 percent by weight, based on the total weight of the molding composition. It may be preferable that the molding composition disclosed comprises at least one elastomer at a proportion of 45 to 90 percent by weight. It may be further preferable that the molding composition disclosed comprises at least one elastomer at a proportion of 50 to 85 percent by weight. The molding composition disclosed may comprise, for example, 55, 60, 65, 70, 75 or 80 percent by weight of at least one elastomer.

If at least one elastomer is present in the molding composition disclosed, specifically at least natural rubber or at least one synthetic rubber, the amount of plasticizer composition disclosed in the molding composition is generally 1 to 60 phr. It may be preferable that the amount of disclosed plasticizer composition in the molding composition is 2 to 40 phr and further 3 to 30 phr. The amount of plasticizer composition disclosed which is present in the molding composition can be, for example, 5, 10, 15, 20 or 25 phr.

A mixture of at least one thermoplastic and at least one elastomer can also be present in the molding composition disclosed. For instance, a mixture of polyvinyl chloride and at least one elastomer can be present in the molding composition disclosed.

If polyvinyl chloride and at least one elastomer is present in the molding composition, the content of elastomer is generally 1 to 50 percent by weight, based on the total weight of the molding composition. It may be preferable that the content of elastomer is 3 to 40 percent by weight, based on the total weight of the molding composition. It may be further preferable that the content of elastomer is 5 to 30 percent by weight, based on the total weight of the molding composition. The molding composition disclosed may comprise, for example, 10, 15, 20 or 25 percent by weight of elastomer.

Depending on the composition of the mixture of polyvinyl chloride and at least one elastomer in the molding composition, the required amount of disclosed plasticizer composition in the molding composition for achieving the desired properties can vary widely. The appropriate amount of the disclosed plasticizer composition to use in order to achieve the desired properties is a matter of routine to a person skilled in the art.

As a rule, the amount of disclosed plasticizer composition in the molding composition comprising polyvinyl chloride and at least elastomer is 0.5 to 300 phr. It may be preferable that the amount of disclosed plasticizer composition in the molding composition comprising polyvinyl chloride and at least one elastomer is 1 to 150 phr and further 2 to 120 phr. The amount of plasticizer composition disclosed which is present in the molding composition can be, for example, 5, 10, 15, 20, 25, 30, 35, 40, 45, 50, 55, 60, 65, 70, 75, 80, 85, 90, 95, 100, 105, 110 or 115 phr.

A molding composition comprising the disclosed plasticizer composition and at least one elastomer can also comprise further additives. Additives can be, for example, carbon black, silicon dioxide, phenolic resins, vulcanizing or crosslinking agents, vulcanizing or crosslinking accelera-tors, activators, various oils, age resistors or a mixture of the additives specified.

Further additives can be substances which a person skilled in the art would admix, owing to his specialist knowledge in tires or other rubber compostions, in order to achieve a certain effect.

A subject matter of the disclosure is likewise a plastisol comprising the disclosed plasticizer composition and at least one polymer.

The plastisol disclosed may accordingly also comprise a mixture of polymers.

In general, a plastisol is a suspension of finely-powdered polymer in liquid plasticizer, in which the dissolution rate of the polymer in the liquid plasticizer is very low at room temperature. On heating the suspension of finely-powdered polymer in liquid plasticizer, a substantially homogeneous phase between polymer and plasticizer is formed. In this case, the individual isolated plastic components swell and combine to give a three-dimensional highly viscous gel. This procedure is generally referred to as gelation and takes place from a certain minimum temperature. This minimum temperature is generally referred to as the gelling or dissolution temperature. The heat required for this can be introduced by means of the parameters of temperature and/or residence time. The more rapidly the gelling proceeds (indication here is the dissolution temperature, i.e. the lower this is, the more rapidly the plastisol gels), a lower temperature (at the same residence time) or residence time (at the same temperature) can be selected.

As a rule, at least one thermoplastic is present in a plastisol.

A plastisol may comprise, for example

| | Trialkyl trimellitate and | |
|---|---|---|
| | dialkyl terephthalate | |
| Thermoplastic | I.3 and II.1 | I.3 and II.2 |
| TP 30 | X | |
| TP 30 | | X |
| TP 30 | X | X |
| TP 29 | X | |
| TP 29 | | X |
| TP 29 | X | X |
| Homo- and/or copolymers of vinyl acetate | X | |
| Homo- and/or copolymers of vinyl acetate | | X |
| Homo- and/or copolymers of vinyl acetate | X | X |
| Homo- and/or copolymers of styrene | X | |
| Homo- and/or copolymers of styrene | | X |
| Homo- and/or copolymers of styrene | X | X |
| TP14 | X | |
| TP14 | | X |
| TP14 | X | X |
| TP 6 | X | |
| TP 6 | | X |
| TP 6 | X | X |
| TP 7 | X | |
| TP 7 | | X |
| TP 7 | X | X |
| | Trialkyl trimellitate and | |
| | dialkyl terephthalate | |
| Thermoplastic | I.4 and II.1 | I.4 and II.2 |
| TP 30 | X | |
| TP 30 | | X |
| TP 30 | X | X |
| TP 29 | X | |
| TP 29 | | X |
| TP 29 | X | X |
| Homo- and/or copolymers of vinyl acetate | X | |
| Homo- and/or copolymers of vinyl acetate | | X |
| Homo- and/or copolymers of vinyl acetate | X | X |
| Homo- and/or copolymers of styrene | X | |
| Homo- and/or copolymers of styrene | | X |
| Homo- and/or copolymers of styrene | X | X |
| TP14 | X | |
| TP14 | | X |
| TP14 | X | X |
| TP 6 | X | |
| TP 6 | | X |
| TP 6 | X | X |
| TP 7 | X | |
| TP 7 | | X |
| TP 7 | X | X |

Depending on the polymer which is present in the plastisol, it may be that, in order to achieve the desired plastisol properties, various amounts of the disclosed plasticizer composition have to be present in the plastisol. Adjustment of the desired plastisol properties is generally a matter of routine to a person skilled in the art.

If the plastisol comprises polyvinyl chloride, the fraction of the disclosed plasticizer composition in the plastisol is typically 30 to 400 phr, preferably 50 to 200 phr.

The content of plasticizers of the general formula (I) in a plastisol comprising polyvinyl chloride is usually at least 10 phr, can be preferably at least 15 phr and can be especially at least 20 phr.

The plasticizer composition disclosed can be used as plasticizer for a polymer or a mixture of polymers.

The plasticizer composition disclosed can be used as plasticizer for a thermoplastic or a mixture of thermoplastics.

The plasticizer composition disclosed can also be used as plasticizer for an elastomer or a mix-tore of elastomers.

An elastomer can be a natural rubber or a rubber produced by a synthetic route. Rubber produced by a synthetic route can be, for example, polyisoprene rubber, styrene-butadiene rubber, butadiene rubber, nitrile-butadiene rubber, chloroprene rubber or any desired mixture thereof.

The plasticizer composition disclosed can also be used as plasticizer for a mixture comprising at least one elastomer and at least one thermoplastic.

The plasticizer composition disclosed is usually used as plasticizer for polyvinyl chloride or a mixture of polymers comprising polyvinyl chloride.

The plasticizer composition disclosed can be used as plasticizer in a plastisol.

The plasticizer composition disclosed is usually used as plasticizer in a plastisol comprising polyvinyl chloride.

The molding composition disclosed is used in the production of moldings or films.

Moldings may be, for example, containers, apparatuses or foamed devices.

Containers may be, for example, housings for electrical appliances such as kitchen appliances or computer housings, tubes, hoses such as water or irrigation hoses, industrial rubber hoses, chemical hoses, sheathings for wire or cables, sheathings for tools, bicycle, roller or wheelbar-row handles, metal coatings or packing containers.

Apparatuses may be, for example, tools, furniture such as stools, shelves, tables, records, profiles such as window profiles, floor profiles for exteriors or profiles for conveyor belts, components for vehicle construction such as bodywork constituents, underbody protection, vibration dampers, or erasers.

Foamed devices may be, for example, cushions, mattresses, foams or insulation materials.

Films may be, for example, tarpaulins such as vehicle tarpaulins, roof tarpaulins, geomembranes, stadium roofs or tent tarpaulins, seals, composite films such as films for composite safe-ty glass, self-adhesive films, laminating films, shrink films, floor coverings for exteriors, adhesive strip films, coatings, films for swimming pools, films for ornamental ponds, tablecloths or artificial leather.

The molding composition disclosed can be used for producing moldings or films which come into direct contact with humans or foodstuffs.

Moldings or films which come into direct contact with humans or foodstuffs may be, for example, medicinal products, hygiene products, food packaging, products for interior space, products for babies and children, childcare articles, sport or leisure products, clothing, fibers or fabric.

Medicinal products which can be produced using the molding composition disclosed may be, for example, tubes for enteral nutrition or hemodialysis, breathing tubes, draining tubes, infusion tubes, infusion bags, blood bags, catheters, tracheal tubes, disposable syringes, gloves or breathing masks.

Food packaging which can be produced using the molding composition disclosed may be, for example, freshness retention films, sleeves for food products, drinking water tubes, containers for storing or freezing foodstuffs, gaskets, sealing caps, bottle caps or plastic wine corks.

Products for interior space which can be produced using the molding composition disclosed may be, for example, floor coverings, which can be constructed homogeneously or composed of several layers consisting of at least one foamed layer, such as ground coverings, mud flap mats, sports floors, luxury vinyl tiles (LVT), artificial leather, wallcoverings, foamed or non-foamed wallpaper in buildings, cladding or console covers in vehicles.

Products for babies and children, which can be produced using the molding composition disclosed may be, for example, toys, such as dolls, game pieces or modelling clays, inflatable toys such as balls or rings, slipper socks, swimming aids, stroller coverings, diaper-changing pads, hot-water bottles, teething rings or flasks.

Sport or leisure products, which can be produced using the molding composition disclosed may be, for example, gymnastic balls, exercise mats, seat cushions, massage balls or rollers, shoes, shoe soles, balls, air mattresses or drinking bottles.

Clothing, which can be produced using the molding composition disclosed may be, for example, latex clothing, protective clothing, rain jackets or rubber boots.

Plastisols are typically made into the form of the finished product at ambient temperature by various processes such as coating processes, casting processes such as the slush molding process or rotomolding process, dip-coating processes, printing processes such as screen printing, spray processes and the like. Subsequently, gelation is effected by heating whereupon, after cooling, a homogeneous more or less flexible product is obtained.

The plastisol disclosed may be used for producing films, wallcoverings, seamless hollow bodies, gloves or for application in the textile sector such as, for example, textile coatings.

Films may be, for example, vehicle tarpaulins, roof tarpaulins, coverings in general such as boat coverings, stroller coverings or stadium roofs, tent tarpaulins, geomembranes, tablecloths, coatings, films for swimming pools, artificial leather or films for ornamental ponds.

Gloves may be, for example, gardening gloves, medicinal gloves, gloves for handling chemi-cals, protective gloves or disposable gloves.

Furthermore, the plastisol disclosed can be used, for example, for producing seals, for example, such as gaskets, cladding or console covers in vehicles, dolls, game pieces or modelling clays, inflatable toys such as balls or rings, slipper socks, swimming aids, diaper-changing pads, gymnastic balls, exercise mats, seat cushions, vibrators, massage balls or rollers, latex clothing, protective clothing, rain jackets or rubber boots.

The plastisol disclosed usually comprises polyvinyl chloride.

Also a subject matter of the disclosure is the use of the disclosed plasticizer composition as calendering aid or rheology aid. Also subject matter of the present disclosure is the use of the disclosed plasticizer composition in surface-active compositions such as flow promoters and film-forming auxiliaries, defoamers, antifoamers, wetting agents, coalescents or emulsifiers. The plasticizer composition disclosed can also be used in lubricants such as lubricant oils, lubricant greases or lubricant pastes. The plasticizer composition disclosed can also be used as quenching agent for chemical reactions, phlegmatizers, in pharmaceutical products, in adhesives, in sealants, in printing inks, in impact modifiers or means of adjustment.

Subject matter of the disclosure are moldings or films comprising the plasticizer composition disclosed. Reference is made to the statements made on the use of molding compositions for producing moldings or films to provide moldings or films. The examples listed here for moldings or films are used for configuring the concepts of moldings or films in this section.

Preparing compound of the general formula (I)

Compounds of the general formula (I) can be prepared, for example, by esterifying corresponding tricarboxylic acids, 1,2,4-benzenetricarboxylic acid for example, with the appropriate aliphatic alcohols. Methods and specific process steps are either known to a person skilled in the art or are accessible to him/her by his/her general technical knowledge.

These include the reaction of at least one alcohol component, selected from the alcohols R^{1a}—OH, R^{1b}—OH, and R^{1c}—OH with an appropriate tricarboxylic acid, 1,2,4-benzenetricarboxylic acid for example, or a suitable derivative thereof. Suitable derivatives are, for example, acid halides and acid anhydrides. An acid halide may be an acid chloride for example. The reaction may be carried out in the presence of an esterification catalyst.

The esterification catalysts used can be customary catalysts for this purpose, e.g. mineral acids such as sulfuric acid or phosphoric acid; organic sulfonic acids such as methanesulfonic acid or p-toluenesulfonic acid; amphoteric catalysts, especially titanium, tin(IV) or zirconium compounds such as, e.g. tetrabutoxytitanium, or tin(IV) oxide. The water which forms in the reaction can be removed by customary measures, by distillation for example. For instance, WO 02/038531 de-scribes a method for preparing esters in which a) a mixture consisting essentially of the acid component or an anhydride thereof and the alcohol component are heated to boiling in a reaction zone in the presence of an esterification catalyst, b) the vapors comprising the alcohol and water are separated by rectification into an alcohol-rich fraction and a water-rich fraction, c) the alcohol-rich fraction is recycled to the reaction zone and the water-rich fraction is discharged from the process. The catalysts mentioned above are used as esterification catalysts. The esterification catalyst is used in an effective amount, which is typically in the range from 0.05 to 10% by weight, preferably 0.1 to 5% by weight, based on the sum total of acid component (or anhydride) and alcohol component. Further detailed descriptions for carrying out esterification processes are found, for example in U.S. Pat. No. 6,310,235 B1, U.S. Pat. No. 5,324,853 A, DE-A 2612355 (Derwent Abstract No. DW 77-72638 Y) or DE-A 1945359 (Derwent Abstract No. DW 73-27151 U). Reference is fully made to the documents specified.

In general, the esterification of the appropriate tricarboxylic acids, 1,2,4-benzenetricarboxylic acid for example, may be carried out in the presence of the aforementioned alcohol components R^{1a}—OH, R^{1b}—OH and/or R^{1c}—OH by means of an organic acid or mineral acid, especially concen-trated sulfuric acid. It may be advantageous in this case that the alcohol component is used in at least a two-fold stoichiometric amount, based on 1,2,4-benzenetricarboxylic acid or a derivative thereof.

The esterification can be effected at ambient pressure or reduced or elevated pressure. It may be preferable that the esterification is carried out at ambient pressure or reduced pressure.

The esterification may be carried out in the absence of an added solvent or in the presence of a solvent.

If the esterification is carried out in the presence of a solvent, it is preferably a solvent inert under the reaction conditions. Inert solvent is generally understood to mean a solvent which, under the given reaction conditions, does not enter into any reactions with the reactants, reagents or solvents involved in the reaction or the products which form. Preferably, the inert solvent can form an azeotrope with water. These include, for example, aliphatic hydrocarbons, halogenated aliphatic hydrocarbons, aromatic and substituted aromatic hydrocarbons or ethers. It may be preferable that the solvent is selected from pentane, hexane, heptane, ligroin, petroleum ether, cyclohexane, dichloromethane, trichloromethane, tetrachloromethane, benzene, toluene, xy-leve, chlorobenzene, dichlorobenzenes, dibutyl ether, THF, dioxane and mixtures thereof.

The esterification is typically carried out in a temperature range from 50 to 250° C.

If the esterification catalyst is selected from organic acids or mineral acids, the esterification is typically carried out in a temperature range from 50 to 160° C.

If the esterification catalyst is selected from amphoteric catalysts, the esterification is typically carried out in a temperature range from 100 to 250° C.

The esterification can be effected in the absence or presence of an inert gas. An inert gas is generally understood to mean a gas which, under the given reaction conditions, does not enter into any reactions with the reactants, reagents or solvents involved in the reaction or the products which form. It may be preferable that the esterification is effected without adding an inert gas.

For example, the alcohol and the acid are combined without inert gas in a molar ratio of the functional groups of 2:1 in a stirred flask together with the esterification catalyst aluminum trime-thylsulfonate in a molar ratio of 400:1, based on the acid. The reaction mixture is heated to boiling point, preferably from 100 to 140° C. The water which forms in the reaction is distilled off as an azeotrope together with the alcohol and is subsequently separated off. The alcohol is fed back again to the reaction mixture.

The 1,2,4-benzenetricarboxylic acid and aliphatic alcohols used to prepare the compounds of the general formula (I) can either be purchased commercially or can be prepared by synthetic routes known from the literature.

### Transesterification

The compounds of the general formula (I) can also be prepared by transesterification. Transesterification methods and specific process steps are either known to a person skilled in the art or are accessible to him/her by his/her general technical knowledge. In general, compounds of the general formula (I) in which R^{1a}, R^{1b} and R^{1c} are each independently to C₂-alkyl serve as reactants. This includes for example the reaction of appropriate trialkyl tricarboxylates, for example trimethyl trimellitate, triethyl trimellitate, dimethyl ethyl trimellitate or methyl diethyl trimellitate or mixtures thereof, with at least one alcohol component selected from the alcohols R^{1a}—OH, R^{1b}—OH and R^{1c}—OH, where R^{1a}, R^{1b} and R^{1c} are C₃- to C₅-alkyl, in the presence of a suitable transesterification catalyst.

Suitable transesterification catalysts are, for example, the customary catalysts commonly used for transesterification reactions, which are also usually used in esterification reactions. These include, e.g. mineral acids such as sulfuric acid or phosphoric acid; organic sulfonic acids such as methanesulfonic acid or p-toluenesulfonic acid; or specific metal catalysts from the group comprising tin(IV) catalysts, for example dialkyltin dicarboxylates such as dibutyltin diacetate, trialkyltin alkoxides, monoalkyltin compounds such as monobutyltin dioxide, tin salts such as tin acetate or tin oxides; from the group comprising titanium catalysts, monomeric or polymeric ti-tanates or titanium chelates such as tetraethyl orthotitanate, tetrapropyl orthotitanate, tetrabutyl orthotitanate, triethanolamine titanate; from the group comprising zirconium catalysts, zir-conates or zirconium chelates such as tetrapropyl zirconate, tetrabutyl zirconate, triethanolamine zirconate; and lithium catalysts such as lithium salts, lithium alkoxides; or aluminum(III), chromium(III), iron(III), cobalt(II), nickel(II) and zinc(II) acetylacetonate.

The amount of transesterification catalyst used can in general be 0.001 to 10% by weight. It may be preferable that the amount is 0.05 to 5% by weight. The reaction mixture is generally heated to the boiling point of the reaction mixture such that the reaction temperature, depending on the reactants, is in a temperature range from 20 to 200° C.

The transesterification can be effected at ambient pressure or reduced or elevated pressure. It may be preferable that the transesterification is carried out at a pressure from 0.001 to 200 bar and more preferably at a pressure from 0.01 to 5 bar.

The lower-boiling alcohol cleaved off in the transesterification, for the purpose of shifting the equilibrium of the transesterification reaction, can be continuously distilled off. The distillation column required for this purpose is generally in direct contact with the transesterification reactor. For example, the distillation column can be installed directly on the transesterification reactor. In the case of the use of two or more transesterification reactors connected in series, each of these reactors may be equipped with a distillation column or the alcohol mixture evaporated off can be fed via one or more collecting lines to a distillation column, preferably from the last tank of the transesterification reactor cascade. The higher-boiling alcohol recovered in this distillation is preferably fed back again to the transesterification.

In the case of the use of an amphoteric catalyst, the removal thereof is generally achieved by hydrolysis and subsequent removal of the metal oxide formed, for example by filtration. It may be preferable that, after reaction is complete, the catalyst is hydrolyzed by washing with water and the precipitated metal oxide is filtered off. The filtrate can be subjected to further processing for isolating and/or purifying the product. It may be preferable that the product is separated by distillation.

The transesterification of the tri(C₁-C₂)-alkyl esters of appropriate tricarboxylic acids, 1,2,4-benzenetricarboxylic acid for example, with at least one alcohol component selected from the alcohols R^{1a}—OH, R^{1b}—OH and R^{1c}—OH, where R^{1a}, R^{1b} and R^{1c} are C₃- to C₅-alkyl, can be carried out preferably in the presence of at least one titanium(IV) alkoxide. Preferred titanium(IV) alkoxides are tetrapropoxy titanium, tetrabutoxy titanium or mixtures thereof. It may be preferable that the alcohol component is used in at least a two-fold stoichiometric amount, based on the tri(C₁-C₂-alkyl) ester used.

The transesterification may be carried out in the absence or in the presence of an added solvent. It may be preferable that the transesterification is carried out in the presence of an inert solvent. Suitable solvents are those mentioned above for esterification. These especially include toluene and THF.

The temperature in the transesterification is generally in a range from 20 to 200° C.

The transesterification can be effected in the absence or presence of an inert gas. An inert gas is generally understood to mean a gas which, under the given reaction conditions, does not enter into any reactions with the reactants, reagents or solvents involved in the reaction or the products which form. It may be preferable that the transesterification is carried out without addition of an inert gas.

### Preparation of Compounds of the General Formula (II)

The compounds of the general formula (II) can either be purchased commercially or can be prepared by methods which are either known to those skilled in the art or which are accessible to them by their general technical knowledge.

As a rule, dialkyl terephthalates are obtained by esterification of terephthalic acid or suitable derivatives thereof with the corresponding alcohols. Methods and specific process steps are either known to those skilled in the art or are accessible to them by their general technical knowledge.

Common to methods for preparing the compounds of the general formula (II) is that, starting from terephthalic acid or suitable derivatives thereof, an esterification or transesterification is carried out in which the corresponding CB-alkanols are used as reactants. These alcohols are generally not pure substances but are isomeric mixtures, the composition and degree of purity of which depends on the respective methods with which these have been prepared.

Preferred C₈-alkanols, which are used for preparing the compounds (II) present in the plasticizer composition according to the invention, can be straight-chain or branched or consist of mixtures of straight-chain and branched C₈-alkanols. These include n-octanol, isooctanol or 2-ethylhexanol. It may be preferable that 2-ethylhexanol is used.

### Octanol

2-Ethylhexanol, which for many years was the plasticizer alcohol produced in the largest quanti-ties, can be obtained, for example, by the aldol condensation of n-butyraldehyde to give 2-ethylhexenal and subsequent hydrogenation thereof to give 2-ethylhexanol (see Ullmann's Encyclopedia of Industrial Chemistry; 5th Edition, Vol. A 10, pp. 137-140, VCH Verlagsgesell-schaft GmbH, Weinheim 1987).

Largely straight-chain octanols can be obtained, for example, by the rhodium- or preferably co-balt-catalyzed hydroformylation of 1-heptene and subsequent hydrogenation of the resulting n-octanal to give n-octanol. The 1-heptene required for this can be obtained, for example, from Fischer-Tropsch synthesis of hydrocarbons.

The alcohol isooctanol, in contrast to 2-ethylhexanol or n-octanol, by reason of its manner of production, is generally not a single chemical compound, but rather is an isomeric mixture of various branched Cₑ-alcohols, for example composed of 2,3-dimethyl-1-hexanol, 3,5-dimethyl-1-hexanol, 4,5-dimethyl-1-hexanol, 3-methyl-1-heptanol and 5-methyl-1-heptanol which, depending on the production conditions and processes applied, may be present in the isooctanol in various ratios. Isooctanol is typically prepared by the co-dimerization of propene with butenes such as n-butenes, and subsequent hydroformylation of the mixture of heptene isomers obtained. The octanal isomer mixture obtained in the hydroformylation can subsequently be hydrogenated to isooctanol in a conventional manner.

The co-dimerization of propene with butenes to give isomeric heptenes can be effected, for example, with the aid of the homogeneously catalyzed Dimersol® process (for example Chauvin et al; Chem. Ind.; May 1974, pp. 375-378), in which a soluble nickel phosphine complex serves as catalyst in the presence of an ethylaluminum chlorine compound, for example ethylaluminum dichloride. The phosphine ligands that can be used for the nickel complex catalyst are e.g. tribu-tylphosphine, triisopropylphosphine, tricyclohexyiphosphine and/or tribenzylphosphine. The reaction takes place generally at temperatures from 0 to 80° C., wherein it may be advantageous to set a pressure in which the olefins are present in dissolved form in the liquid reaction mixture (for example Cornils; Hermann: Applied Homogeneous Catalysis with Organometallic Compounds; 2nd edition; Vol. 1; pp. 254-259, Wiley-VCH, Weinheim 2002).

As an alternative to the Dimersol® process operated with nickel catalysts homogeneously dissolved in the reaction medium, the co-dimerization of propene with butenes can also be carried out with heterogeneous NiO catalysts precipitated on a support, in which similar heptene isomer distributions are obtained to the homogeneously catalyzed process. Such catalysts are used, for example, in the so-called Octol® process (Hydrocarbon Processing, February 1986, pp. 31-33); a particularly suitable specific heterogeneous nickel catalyst for olefin dimerization or co-dimerization is disclosed, for example, in WO 9514647.

Instead of catalysts based on nickel, heterogeneous Brønsted acid catalysts for co-dimerizing propene with butenes can also be used, in which generally more highly branched heptenes are obtained than in the nickel-catalyzed processes. Examples of catalysts suitable for this purpose are solid phosphoric acid catalysts, for example kieselguhr or diatomaceous earth impregnated with phosphoric acid, such as are used, for example, in the PolyGas® process for olefin dimerization or oligomerization (for example Chitnis et al; Hydrocarbon Engineering 10, No. 6—June 2005). For the co-dimerization of propene and butenes to give heptenes, very well-suited Brønsted acid catalysts are mostly zeolites, which is served for example by the further devel-oped EMOGAS® process based on the PolyGas® process.

1-heptene and the heptene isomeric mixtures are converted to n-octanal or octanal isomeric mixtures by the known methods elucidated in connection with the preparation of n-heptanal and heptanal isomeric mixtures, by means of rhodium- or cobalt-catalyzed hydroformylation, preferably cobalt-catalyzed hydroformylation. These are subsequently hydrogenated to the corresponding octanols, for example by means of the catalysts mentioned above in connection with the preparation of n-heptanol and isoheptanol.

### EXAMPLES

The invention is illustrated in more detail by reference to the figures and examples described below. Here, the figures and examples should not be construed as being limiting for the invention. In the examples, the following feedstocks are used:

| | Commercially available for example | |
|---|---|---|
| Feedstocks | as | from |
| Homopolymeric | Solvin ® 367 NC | Inovyn ChlorVinyls |
| emulsion PVC | | Limited |
| Homopolymeric | Solvin ® 271 SP | Inovyn ChlorVinyls |
| emulsion PVC | | Limited |
| Homopolymeric | Vinnolit ® P 70 | Vinnolit GmbH |
| emulsion PVC | | |
| Isononyl benzoate | Vestinol ® INB | Evonik Performance |
| | | Materials GmbH |
| Isodecyl benzoate | Jayflex ® MB 10 | Exxonmobil Petroleum |
| | | Chemical BVBA |
| Di(2-ethylhexyl) | EASTMAN 168 ™ | Eastman Chemical B.V. |
| terephthalate | | |
| (compound II.1) | | |
| Diisononyl phthalate | Palatinol ® N | BASF SE |
| Tri(2-ethylhexyl) | Palatinol ® TOTM | BASF Corp. |
| trimellitate | | |
| Ba—Zn stabilizer | Reagent SLX/781 | Reagens S.p.A. |

In all examples, homopolymeric emulsion PVC was used as Solvin® 367 NC and/or Vinnolit® P 70, isononyl benzoate as Vestinol® INB, isodecyl benzoate as Jayflex® MB 10, di(2-ethylhexyl) terephthalate as EASTMAN 168™, diisononyl phthalate as Palatinol® N, tri(2-ethylhexyl) trimellitate as Palatinol® TOTM and the Ba-Zn stabilizer as Reagent SLX/781. The product properties, insofar as the data sheets of the manufacturers are available, are specified in the following table.

| Product | Vestinol ® | Jayflex ® | EASTMAN | Palatinol ® | Palatinol ® |
|---|---|---|---|---|---|
| properties | INB | MB 10 | 168 ™ | N | TOTM |
| Density | 0.955-0.963 | 0.950-0.955 | 0.98 g/ml | 0.970-0.977 | 0.98-0.99 |
| | g/ml at 20° C., | g/ml at 20° C., | at 20° C. | at 20° C., | g/ml at 20° C., |
| | DIN 51757 | ASTM D- | | DIN 51757 | DIN 51757 |
| | (January 2011) | 4052-15 | | (January 2011) | (January 2011) |
| Viscosity | 8.4 mPa*s | 5-15 mPa*s | 49-63 cP | 68-82 mPa*s | 293.6 mPa*s |
| | at 20° C., | at 20° C., | at 25° C., | at 20° C., | at 20° C., |
| | DIN 53015, | ASTM D- | ASTM D | ASTM D | DIN 53015, |
| | (February 2001) | 445-15 | 445-15 | 7042-14 | (February 2001) |
| Acid | max. 0.07 | max. 0.07 | | max. 0.06 | 0.079 mg |
| number | mg KOH/g, | mg KOH/g, | | mg KOH/g, | KOH/g, DIN |
| | DIN EN ISO | ASTM D- | | DIN EN ISO | EN ISO 2114 |
| | 2114 | 1045-14 | | 2114 | (June 2002) |
| | (June 2002) | | | (June 2002) | |
| Refractive | 1.488-1.494 | 1.489-1.491 | 1.486-1.488 | 1.484-1.488 | 1.485-1.487 |
| index | at 20 85° C., | at 20° C., | at 25° C. | at 20° C., | at 20° C., |
| | DIN 51423/2 | ASTM D- | | DIN 51423/2 | DIN 51423/2 |
| | (February 2010) | 1218 | | (February 2010) | (February 2010) |

### Examples

### I) Preparation of Two Compounds of the General Formula (I) According to the Disclosure:

### Example 1

### Synthesis of tri(isobutyl) 1,2,4-benzenetricarboxylate (Compound I.4)

1000 g of 1,2,4-benzenetricarboxylic anhydride and 1400 g of isobutanol were initially charged under a protective gas, for example nitrogen. A gentle protective gas stream was further passed through the complete apparatus. After 15 minutes, 1 ml of the titanium catalyst (Tyzor® TPT-20B, Dorf Ketal B.V., 4700 BN Roosendaal/NL, butoxyisopropoxytitanium, CAS No. 68955-22-6, density at 20° C. ca. 0.97 g/ml) was added. The mixture was heated to reflux with stirring. The reaction course was controlled with the aid of a water separator. After about 150 ml of water had been collected in the water separator, the acid number was determined (in accordance with DIN EN ISO 2114 06/2002). At a value of 55 mg KOH or below, a portion of the moist isobutanol was replaced with fresh dry isobutanol and the reaction was continued under reflux until the acid number had fallen below a value of 1 mg KOH. The reaction mixture was cooled to about 100° C. and a 20% aqueous sodium hydroxide solution was then added and the mixture stirred for 30 minutes. The amount of aqueous sodium hydroxide solution required was calculated by the acid number AN:

Amount of 20% NaOH(aq) in ml=5*(AN*product weight/1000)*I.4

Excess alcohol was distilled off under reduced pressure. About 50 g of Fuller's earth was added to the still warm mixture and stirred. This was filtered off together with the precipitated catalyst residues.

This gave in total 1850 g (95% yield) of a pale yellowish oily liquid with a purity according to GC of 94%.

### Example 2

### Synthesis of Tri(n-Butyl) 1,2,4-Benzenetricarboxylate (Compound I.3)

The synthesis of tri(n-butyl) 1,2,4-benzenetricarboxylate was carried out in analogy to the synthesis in example 1. An equal amount of n-btanol was used instead of isobutanol.

The product was obtained as a pale yellowish oil in a yield of 1920 g (98%) and a purity of 96%.

The following table gives the properties of the compounds as described above,

| | | | | Dibutyl |
|---|---|---|---|---|
| | | | | Tri(isobutyl) 1,2,4- |
| | | | Tri(n-butyl) 1,2,4- | benzenetricarboxylate |
| | | | benzenetricarboxylate | acetylmalate |
| Product property | Unit | Method | (compound I.3) | (compound I.4) |
| Density, 20° C. | g/cm³ | DIN 51757 | 1.0632 | 1.0499 |
| | | Ver. 4 | | |
| | | January 2011 | | |
| Viscosity, 20° C. | mPa * s | DIN 51562-1 | 195 | 397 |
| | | January 1999 | | |
| Pt/Co color number | | DIN ISO 6271 | 76 | 75 |
| | | March 2005 | | |
| Refractive index, n^{D}₂₀ | | DIN 51423-2 | 1.4930 | 1.4878 |
| | | February 2010 | | |
| Acid number | mg | DIN EN ISO | 0.081 | 0.089 |
| | KOH/g | 2114 | | |
| | | June 2002 | | |
| Water content | % by | DIN 51777, | 0.025 | 0.021 |
| | weight | TI. 1 | | |
| | | March 1983 | | |
| GC purity | % | | 96.1 | 94.3 |
| Dissolution temperature | ° C. | DIN 53408 | 108 | 106 |
| Microscope method | | June 1967 | | |

### II) Performance Tests:

II.a) Determination of the Dissolution Temperature in Accordance with DIN 53408 (06/67) and of the Dynamic Viscosity in Accordance with DIN 51562-1 01/99:

To characterize the gelling behavior of the compounds of the general formula (I) according to the disclosure in PVC, the dissolution temperature was determined in accordance with DIN 53408 (06/67). The lower the dissolution temperature, the better the gelling behavior of the rele-vant substance for PVC.

Listed in the following table are the dissolution temperatures and dynamic viscosities of tri(n-butyl) 1,2,4-benzenetricarboxylate (compound I.3) and tri(isobutyl) 1,2,4-benzenetricarboxylate (compound I.4), and as comparison the values of the gellating aids isononyl benzoate (as Vestinol® INB) and isodecyl benzoate (as Jayflex® MB 10), and also the plasticizers di(2-ethylhexyl) terephthalate (as EASTMAN 168™), diisononyl phthalate (as Palatinol® N) and tri(2-ethylhexyl) trimellitate (as Palatinol® TOTM).

| | | Dissolution | Dynamic |
|---|---|---|---|
| | | temperature in | viscosity in |
| | | accordance with | accordance with |
| | | DIN 53408 | DIN 51562-1 |
| Ex. | | (June 1967) | January 1999 |
| No. | Substance | [° C.] | [mPa · s] |
| 1 | Tri(n-butyl) 1,2,4- | 108 | 195 |
| | benzenetricarboxylate | | |
| | (compound I.3) | | |
| 2 | Tri(isobutyl) 1,2,4- | 106 | 397 |
| | benzenetricarboxylate | | |
| | (compound I.4) | | |
| V1 | Isononyl benzoate | 128 | 8.4 |
| | (as Vestinol ® INB) | | |
| V2 | Isodecyl benzoate | 131 | 10.0 |
| | (as Jayflex ® MB 10) | | |
| V3 | Di(2-ethylhexyl) | 144 | 85 |
| | terephthalate | | |
| | (as EASTMAN 168 ™) | | |
| V4 | Diisononyl phthalate | 131 | 75.0 |
| | (as Palatinol ® N) | | |
| V5 | Tri(2-ethylhexyl) | 144 | 293 |
| | trimellitate | | |
| | (as Palatinol ® TOTM) | | |

As is apparent from the table, compound I.3 and compound I.4 exhibit a lower dissolution temperature for PVC than the gellating aids Vestinol® INB and Jayflex® MB10. The dynamic viscosity is somewhat higher.

As is also apparent from the table, tri(n-butyl) 1,2,4-benzenetricarboxylate and tri(isobutyl) 1,2,4-benzenetricarboxylateexhibit a distinctly lower dissolution temperature for PVC compared to the plasticizers EASTMAN 168™, Palatinol® N and Palatinol® TOTM.

II.b) Determination of the Gelling Behavior of Plastisols with the Plasticizer Composition According to the Disclosure:

To investigate the gelling behavior of plastisols based on the plasticizer compositions disclosed, plastisols were produced according to the following formulations, comprising the PVC and a mixture of the plasticizer di(2-ethylhexyl) terephthalate (as EASTMAN 168™) with tri(n-butyl) 1,2,4-benzenetricarboxylate (compound I.3) or tri(isobutyl) 1,2,4-benzenetricarboxylate (compound I.4) in various ratios (EASTMAN 168™ to tri(n-butyl) 1,2,4-benzenetricarboxylate (compound I.3) 88/12, 75/25 and 78/22, or EASTMAN 168™ to tri(isobutyl) 1,2,4-benzenetricarboxylate (compound I.4) 85/15):

| | phr |
|---|---|
| PVC (mixture of 70 parts by weight homopolymeric emulsion | 100 |
| PVC of type Solvin ® 367 NC and 30 parts by weight | |
| homopolymeric emulsion PVC of type Vinnolit ® P 70) | |
| Plasticizer composition according to the disclosure | 100 |
| Ba—Zn Stabilizer, Reagent SLX/781 | 2 |

Plastisols were also produced as comparison, comprising exclusively, in addition to PVC, the plasticizers di(2-ethylhexyl) terephthalate (as EASTMAN 168™), diisononyl phthalate (as Palatinol® N) or tri(2-ethylhexyl) trimellitate (as Palatinol® TOTM) or plastisols with 73% by weight of the plasticizer EASTMAN 168™ with 27% of the gellating aid Vestinol® INB and a plastisol with 64% of the plasticizer EASTMAN 168™ with 36% of the gellating aid Jayflex® MB 10.

| | phr |
|---|---|
| PVC (mixture of 70 parts by weight homopolymeric emulsion | 100 |
| PVC of type Solvin ® 367 NC and 30 parts by weight | |
| homopolymeric emulsion PVC of type Vinnolit ® P 70) | |
| Plasticizer composition comparison | 100 |
| Ba—Zn Stabilizer, Reagens ® SLX/781 | 2 |

| | Dissolution |
|---|---|
| | temperature |
| | by rheometer |
| Composition | method |
| 100% Tri(n-butyl) 1,2,4-benzenetricarboxylate | 116 |
| (compound I.3) | |
| 100% Tri(isobutyl) 1,2,4-benzenetricarboxylate | 125 |
| (compound I.4) | |
| 100% Di(2-ethylhexyl) terephthalate | 155 |
| (as EASTMAN 168TM) | |
| 100% Diisononyl phthalate | 150 |
| (as Palatinol ® N) | |
| 12% Tri(n-butyl) 1,2,4-benzenetricarboxylate | 150 |
| (compound I.3) + 88% di(2-ethylhexyl) terephthalate | |
| (as EASTMAN 168 ™) | |
| 15% Tri(isobutyl) 1,2,4-benzenetricarboxylate | 150 |
| (compound I.4) + 85% di(2-ethylhexyl) terephthalate | |
| (as EASTMAN 168 ™) | |
| 27% Isononyl benzoate (as Vestinol ® INB) + 73% di(2- | 150 |
| ethylhexyl) terephthalate (as EASTMAN 168 ™) | |
| 36% Isodecyl benzoate (as Jayflex ® MB10) + 64% di(2- | 150 |
| ethylhexyl) terephthalate (as EASTMAN 168 ™) | |

The plastisols were produced in a manner in that the two PVC types were weighed together into a PVC-free apparatus. The liquid components were weighed into a second PVC-free apparatus. With the aid of a dissolver (Jahnke & Kunkel, IKA-Werk, Type RE-166 A, 60-6000 1/min, diame-ter of the dissolver disk=40 mm), the PVC was stirred into the liquid component at 400 rpm. Once a plastisol had been generated, the speed of rotation was increased to 2500 1/min and the mixture homogenized for 150 s. The plastisol was transferred from the PVC-free apparatus to a suitable apparatus, a steel dish for example, and placed under vacuum with the purpose of removing air present in the plastisol. Then, the plastisol was again brought to ambient pressure. The start of the rheological measurements in all plastisols was 30 min after homogenization.

The viscosity measurements were carried out using a heatable oscillation and rotational rheom-eter MCR 302 from Anton Paar in an oscillation test.

| measurement system: | plate/plate d = 50 mm | |
|---|---|---|
| amplitude γ: | 1% | |
| frequency: | 1 | Hz |
| gap width: | 1 | mm |
| starting temperature: | 20° | C. |
| temperature profile: | 20-200° | C. |
| temperature increase: | 10° C./min | |
| measurement points: | 201 | |
| measurement point duration: | 0.09 | min |

The measurement was effected in two ramps. The first ramp served to temperature-control the sample. At 20° C., the plastisol was lightly sheared for 2 min at y=1%. The temperature program was started with the second ramp. During the measurement, the storage modulus and the loss modulus were recorded. From the quotient of these two parameters, the complex viscosity η* is calculated. The temperature which was reached at the viscosity maximum is considered as the gelling temperature of the plastisol.

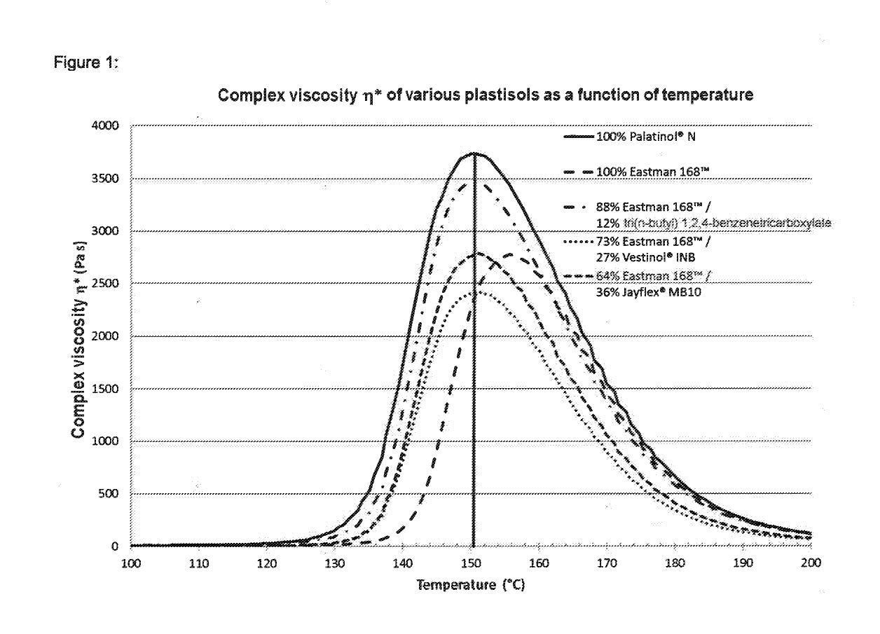

As is very readily apparent in FIG. 1, the plastisols with the plasticizer composition according to the disclosure gel at considerably lower temperatures in comparison to the plastisol exclusively comprising Eastman 168™. Even at a composition of 88% by weight Eastman 168™ and 12% by weight tri(n-butyl) 1,2,4-benzenetricarboxylate (compound I.3), a gelling temperature of 150° C. is achieved, which corresponds to the gelling temperature of the plasticizer Palatinol® N and is sufficient for many plastisol applications. By further increasing the fraction of tri(n-butyl) 1,2,4-benzenetricarboxylate (compound I.3) in the plasticizer compositions according to the disclosure, the gelling temperature of the plastisols can be significantly further reduced.

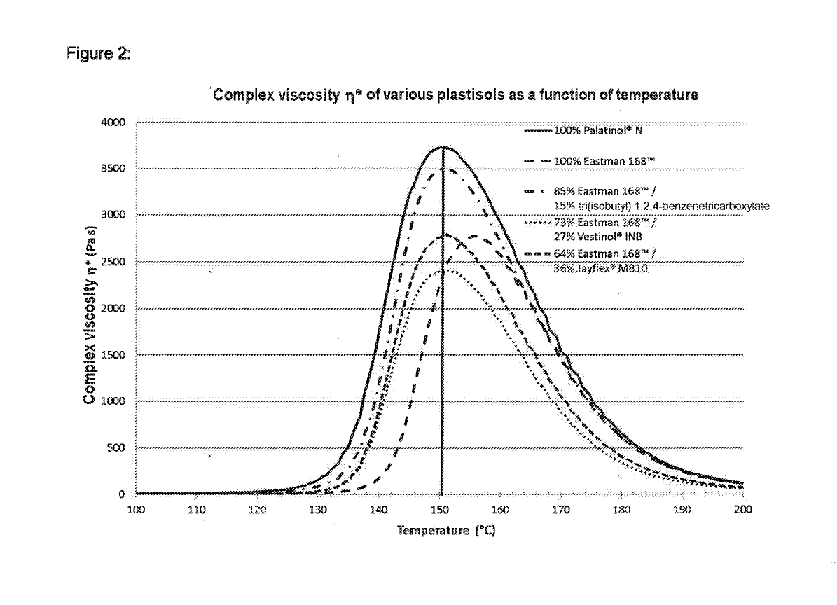

As is apparent from FIG. 2, even at a composition of 85% by weight Eastman 168™ and 15% by weight tri(isobutyl) 1,2,4-benzenetricarboxylate (compound I.4), a gelling temperature of 150° C. is achieved, which corresponds to the gelling temperature of the plasticizer Palatinol® N and is sufficient for many plastisol applications. By further increasing the fraction of tri(isobutyl) 1,2,4-benzenetricarboxylate (compound I.4) in the plasticizer compositions according to the disclosure, the gelling temperature of the plastisols can be significantly further reduced.

In both figures, two comparative examples with gellating aids are included. A plastisol composed of 73% by weight of the plasticizer Eastman 168™ with 27% by weight of the gellating aid Vestinol® INB and a plastisol with 64% by weight of the plasticizer Eastman 168™ with 36% by weight of the gellating aid Jayflex® MB 10. In both cases, the gelling temperature of 150° C. is likewise achieved, which corresponds to the gelling temperature of Palatinol® N.

In contrast, in the plasticizer compositions composed of the gellating aids Vestinol® INB and Jayflex® MB 10, considerably higher proportions of Vestinol® INB (27% by weight) or Jayflex® MB 10 (36% by weight) are required in order to achieve a gelling temperature of the plastisols of 150° C. Tri(n-butyl) 1,2,4-benzenetricarboxylate (compound I.3) or tri(isobutyl) 1,2,4-benzenetricarboxylate (compound I.4) accordingly have a significantly better gelling effect than the commercially available gellating aids Vestinol® INB and Jayflex® MB 10.

### II.c) Determination of the Process Volatility of the Plasticizer Compositions According to the Dis-Closure in Comparison to Plasticizer Compositions of Commercially Available Gellating Aids

Plastisols were produced as described in II.b) with a plasticizer composition composed of 12% by weight tri(n-butyl) 1,2,4-benzenetricarboxylate (compound I.3) and 88% by weight Eastman 168™ or composed of 15% tri(isobutyl) 1,2,4-benzenetricarboxylate (compound I.4) and 85% by weight Eastman 168™ and with the plasticizer compositions composed of 27% by weight Vestinol® INB and 73% by weight Eastman 168™ and also 36% by weight Jayflex® MB 10 and 64% by weight Eastman 168™. The following formulation was used.

| Additive | phr |
|---|---|
| PVC (mixture of 70 parts by weight homopolymeric emulsion | 100 |
| PVC of type Solvin ® 367 NC and 30 parts by weight | |
| homopolymeric emulsion PVC of type Vinnolit ® P 70) | |
| Plasticizer composition | 60 |
| Ba—Zn Stabilizer, Reagens ® SLX/781 | 2 |

Plastisols were also produced as comparison exclusively comprising Eastman 168™, Palatinol® N or tri(isobutyl) 1,2,4-benzenetricarboxylate (compound I.4). The following formulation was used.

| Additive | phr |
|---|---|
| PVC (mixture of 70 parts by weight homopolymeric emulsion | 100 |
| PVC of type Solvin ® 367 NC and 30 parts by weight | |
| homopolymeric emulsion PVC of type Vinnolit ® P 70) | |
| Plasticizer | 60 |
| Ba—Zn Stabilizer, Reagens ® SLX/781 | 2 |

### Production of a Prefilm

In order to be able to determine the performance properties on the plastisols, the liquid plastisol must be converted into a processable solid film. For this purpose, the plastisol was pregelled at low temperature.

The pregelling of the plastisols was effected in a Mathis oven.

Settings on the Mathis oven:
exhaust air: valve fully open
fresh air: open
circulating air: maximum position
top air/bottom air: top air setting 1

### Production of the Prefilm:

A new relay paper was mounted in the mounting device on the Mathis oven. The oven was pre-heated to 140° C.; the gelling time set to 25 s. For the gap setting, the gap between paper and doctor blade was set to 0.1 mm with the thickness template. The thickness gauge was set to 0.1 mm. The gap was then set to a value of 0.7 mm on the gauge.

The plastisol was applied to the paper and spread smooth with the doctor blade. Then, the mounting device was brought into the oven by means of the start button. After 25 s, the mounting device moves out of the oven again. The plastisol was gelled and the film that had formed could be pulled off the paper in one piece. The thickness of this film was ca. 0.5 mm.

### Determination of the Process Volatility

To determine the process volatility, 3 square specimens (49×49 mm) were stamped out of each prefilm with a Shore hardness punch, weighed and then gelled for 2 minutes at 190° C. in the Mathis oven. After cooling, these specimens were reweighed and the weight loss calculated in %. For this, the specimens were always positioned exactly on the same position of the relay paper. For this purpose, at the height of the hole in the frame on which the template for the Petri dishes was secured, a line was drawn diagonally across the paper with a pen. The position of the 3 specimens was aligned with this line. They lay uniformly across the breadth on the paper centered on the line.

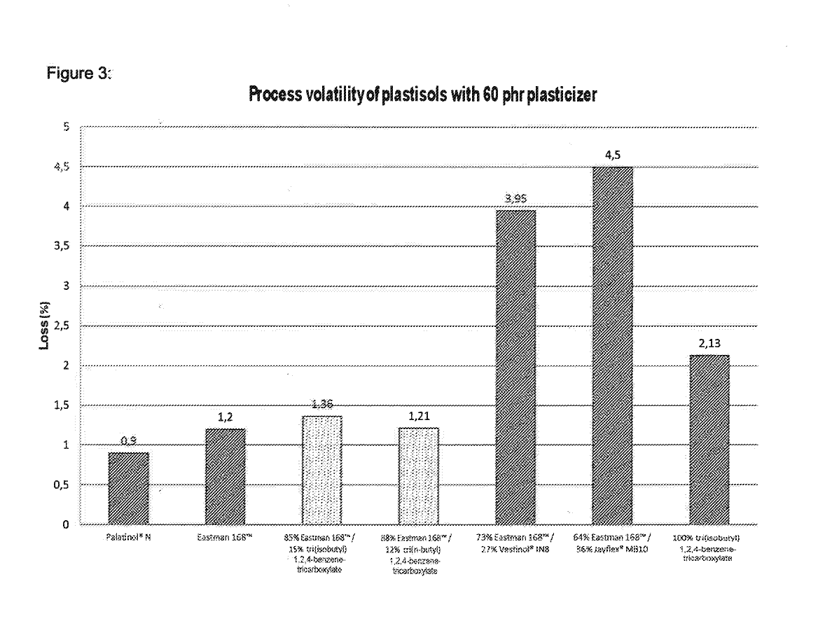

As is very readily apparent from FIG. 3, the process volatility of the plasticizer composition according to the disclosure composed of 12% by weight tri(n-butyl) 1,2,4-benzenetricarboxylate (compound I.3) and 88% by weight Eastman 168™ or 15% tri(isobutyl) 1,2,4-benzenetricarboxylate (compound I.4) and 85% by weight Eastman 168™ is distinctly lower than the process volatility of the plasticizer compositions composed of 27% Vestinol®INB and 73% by weight Eastman 168™ or 36% by weight Jayflex® MB 10 and 64% Eastman 168™. In the plasticizer compositions according to the disclosure, therefore, significantly less plasticizer is lost during processing of the plastisols.

The process volatility of the plasticizer composition according to the disclosure composed of 12% by weight tri(n-butyl) 1,2,4-benzenetricarboxylate (compound I.3) and 88% by weight Eastman 168™ or 15% tri(isobutyl) 1,2,4-benzenetricarboxylate (compound I.4) and 85% by weight Eastman 168™ is slightly higher than the pure plasticizers Eastman 168™ or Palatinol® N, and significantly lower than the process volatility of the pure gellating aid tri(isobutyl) 1,2,4-benzenetricarboxylate(compound I.4).

II.d) Determination of the Shore a Hardness of Films of Plastisols with the Plasticizer Compositions According to the Disclosure in Comparison to Films of Plastisols with the Plasticizer Compositions of Commercially Available Gellating Aids

To determine the Shore A hardness, film pieces of size 49×49 mm were stamped out of the prefilms as described in II.c) and, in analogy to the volatility test, each were gelled in triplicate at 190° C. for 2 min. In total, 27 pieces of films were thus gelled. These 27 pieces were placed on top of one another in the pressing frame and compressed at 195° C. to a 10 mm thick Shore block.

### Description of the Shore Hardness Measurement:

method: DIN EN ISO 868, October 2003
title: Determination of the indentation hardness with a durometer (Shore hardness)
instrument: Hildebrand digital durometer model DD-3
specimens:
   dimensions: 49 mm×49 mm×10 mm (length×breadth×thickness)
   production: pressed from ca. 27, 0.5 mm thick gelled films,
   pressing temperature: 195° C.=5° C. above the preparation of the gelled films
storage period prior to measurement: 7 days in the climate chamber at 23° C. and 50% rel. humidity
measurement time (duration of the needle on the specimens up to read off of the value) 15 s
10 individual values were measured and the mean value calculated therefrom.

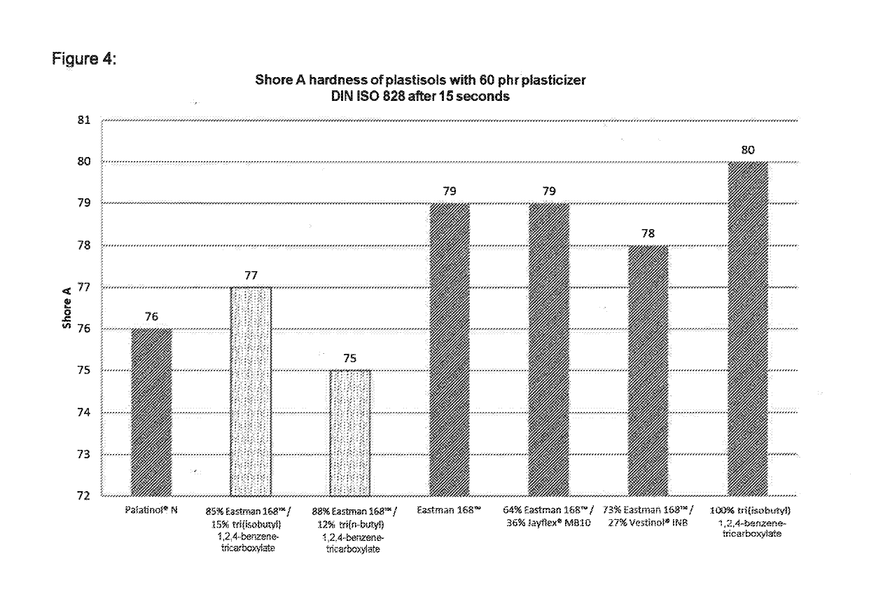

As is very readily apparent from FIG. 4, the Shore A hardness of the film of the plastisol with the disclosed plasticizer composition composed of 12% by weight tri(n-butyl) 1,2,4-benzenetricarboxylate (compound I.3) and 88% by weight Eastman 168™ or 15% tri(isobutyl) 1,2,4-benzenetricarboxylate (compound I.4) and 85% by weight Eastman 168™ is lower than the Shore A hardness of the films of the plastisols with the plasticizer compositions composed of 27% Vestinol® INB and 73% by weight Eastman 168™ or 36% by weight Jayflex® MB 10 and 64% Eastman 168™. The use of the plasticizer composition disclosed therefore results in a higher elasticity of the PVC article.

The Shore A hardness of the film of the PVC plastisol with the disclosed plasticizer composition composed of 12% by weight tri(n-butyl) 1,2,4-benzenetricarboxylate (compound I.3) and 88% by weight Eastman 168™ or 15% tri(isobutyl) 1,2,4-benzenetricarboxylate (compound I.4) and 85% by weight Eastman 168 ™ is moreover also significantly lower than the Shore A hardness of the film of the PVC plastisol with the pure plasticizer Eastman 168™ but is, however, comparable to the Shore A hardness of the film of the PVC plastisol with the pure plasticizer Palatinol® N.

The Shore A hardness of the plasticizer composition disclosed composed of 15% by weight tri(isobutyl) 1,2,4-benzenetricarboxylate (compound I.4) and 85% by weight Eastman 168™ is significantly lower than the Shore A hardness of the films comprising only the plasticizer Eastman 168™ or the gellating aid tri(isobutyl) 1,2,4-benzenetricarboxylate.

II.e) Determination of the Film Volatility of Films of Plastisols with the Plasticizer Compositions According to the Disclosure in Comparison to Films of Plastisols with the Plasticizer Compositions of Commercially Available Gellating Aids

To test the film volatility, plastisols were produced as described in II.c with the plasticizer composition disclosed composed of 12% by weight tri(n-butyl) 1,2,4-benzenetricarboxylate (compound I.3) and 88% by weight Eastman 168™ or 15% tri(isobutyl) 1,2,4-benzenetricarboxylate (compound I.4) and 85% by weight Eastman 168™ and plastisols with the plasticizer compositions composed of 27% by weight Vestinol® INB and 73% by weight Eastman 168™ and also 36% by weight Jayflex® MB 10 and 64% by weight Eastman 168™, Plastisols were also pro-duces as comparison comprising exclusively Eastman 168™ Palatinol® N or tri(isobutyl) 1,2,4-benzenetricarboxylate (compound I.4). For the tests here however, a prefilm was not firstly produced but rather the plastisol was gelled directly at 190° C. for 2 min in the Mathis oven. The test of the film volatility was carried out on the ca. 0.5 mm thick films thus produced.

Test of the film volatility at 130° C. over 24 h:

To determine the film volatility, four single films (150×100 mm) were cut out, punched and weighed from the plastisols gelled at 190° C. for 2 min. The films were suspended on a rotating star in a Heraeus drying cabinet type 5042 E set to 130° C. The air in the cabinet was ex-changed 18 times per hour. This corresponds to 800 I/h of fresh air. After 24 h in the cabinet, the films were removed and reweighed. The weight loss in percent gives the film volatility of the plasticizer compositions.

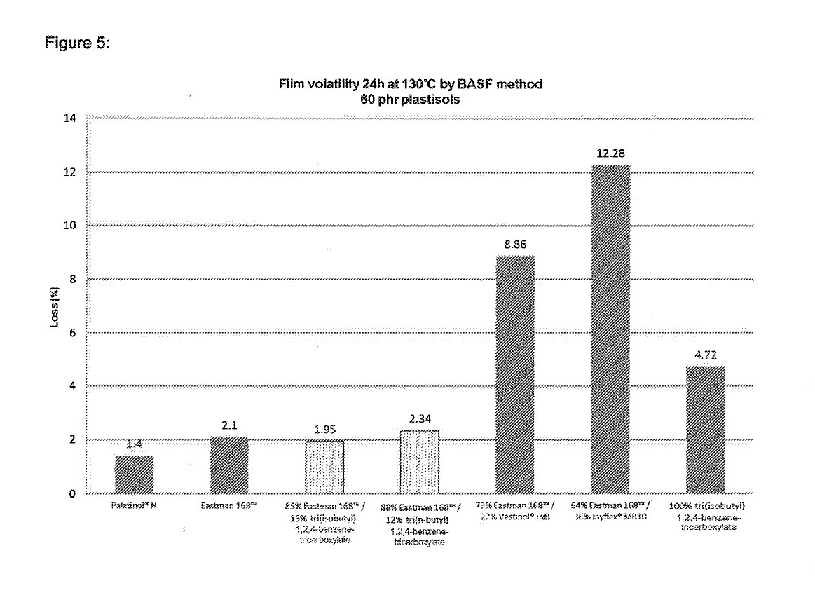

As is very readily apparent from FIG. 5, the film volatility of the disclosed plasticizer composition composed of 12% by weight tri(n-butyl) 1,2,4-benzenetricarboxylate (compound I.3) and 88% by weight Eastman 168™ or 15% tri(isobutyl) 1,2,4-benzenetricarboxylate (compound I.4) and 85% by weight Eastman 168™ is significantly lower than the film volatility of the plasticizer compositions composed of 27% by weight Vestinol® INB and 73% by weight Eastman 168™ and also 36% by weight Jayflex® MB 10 and 64% by weight Eastman 168™. The plasticizer compositions disclosed therefore efflux less in the finished plasticized PVC article.

The film volatility of the plasticizer composition disclosed composed of 12% by weight tri(n-butyl) 1,2,4-benzenetricarboxylate (compound I.3) and 88% by weight Eastman 168™ or 15% tri(isobutyl) 1,2,4-benzenetricarboxylate (compound I.4) and 85% by weight Eastman 168™ is comparable to that of the pure plasticizers Eastman 168™ or Palatinol® N and significantly lower than that of the pure tri(isobutyl) 1,2,4-benzenetricarboxylate (compound I.4).

II.f) Determination of the Compatibility (Permanence) of Films of Plastisols with the Plasticizer Compositions According to the Disclosure in Comparison to Films of Plastisols with the Plasticizer Compositions of Commercially Available Gellating Aids

To test the compatibility, plastisols were produced as described in II.c) with the plasticizer composition disclosed composed of 12% by weight tri(n-butyl) 1,2,4-benzenetricarboxylate (compound I.3) and 88% by weight Eastman 168™ or 15% tri(isobutyl) 1,2,4-benzenetricarboxylate (compound I.4) and 85% by weight Eastman 168™ and plastisols with the plasticizer compositions composed of 100% by weight tri(isobutyl) 1,2,4-benzenetricarboxylate (compound I.4), 27% Vestinol® INB and 73% by weight Eastman 168 ™ and also 36% by weight Jayflex® MB 10 and 64% Eastman 168™. Plastisols were also produced comprising exclusively the plasticizers Eastman 168™ or Palatinol® N. For the tests here however, a prefilm was not firstly produced but rather the plastisol was gelled directly at 190° C. for 2 min in the Mathis oven. The test of the compatibility was carried out on the ca. 0.5 mm thick films thus produced.

### Test Method:

### Purpose of the Test Procedure:

The test provides the qualitative and quantitative measurement of the compatibility of soft PVC formulae. It is conducted at elevated temperature (70° C.) and humidity (100% rel. h). The data obtained are evaluated against storage time.

### Specimens

For the standard test, 10 specimens (films) of size 75×110×0.5 mm were used for each for-mutation. The films were punched, labeled and weighed on the width side. The labelling must be indelible and can be done, for example, using a soldering iron.

### Test Equipment

Heating cabinet, analytical balance, temperature measuring equipment with sensors for measuring the temperature of the interior space of the heating cabinet, glass beakers, metal racks made of rust-proof material;

Test temperature: 70° C.

Test medium: steam formed at 70° C. from completely demineralized water

### Procedure:

The temperature in the interior space of the heating cabinet was adjusted to the required 70° C., The test films were suspended on a wire frame and placed in a glass bowl which had been filled to a height of 5 cm with water (demin. water). Only films of identical composition must be stored in a labeled and numbered beaker in order to avoid mutual interference and to simplify withdrawal after the respective storage times.

The glass bowl was sealed with a PE film impervious to water vapor, so that the water vapor formed in the glass bowl could not escape.

### Storage Time

In a 1, 3, 7, 14 and 28 day rhythm, 2 films (duplicate determination) in each case were removed from the glass bowl and climatized freely suspended in air for 1 hour. Subsequently, the films were cleaned with methanol in the fume hood (tissues moistened with methanol). The films were then dried freely suspended in a drying cabinet (natural convection) at 70° C. for 16 h. After removal from the drying cabinet, the films were conditioned freely suspended in the laboratory for 1 hour and then weighed again. The test result was specified in each case as the arithmetic mean of the weight changes of the samples prior to introduction to the heating cabinet.

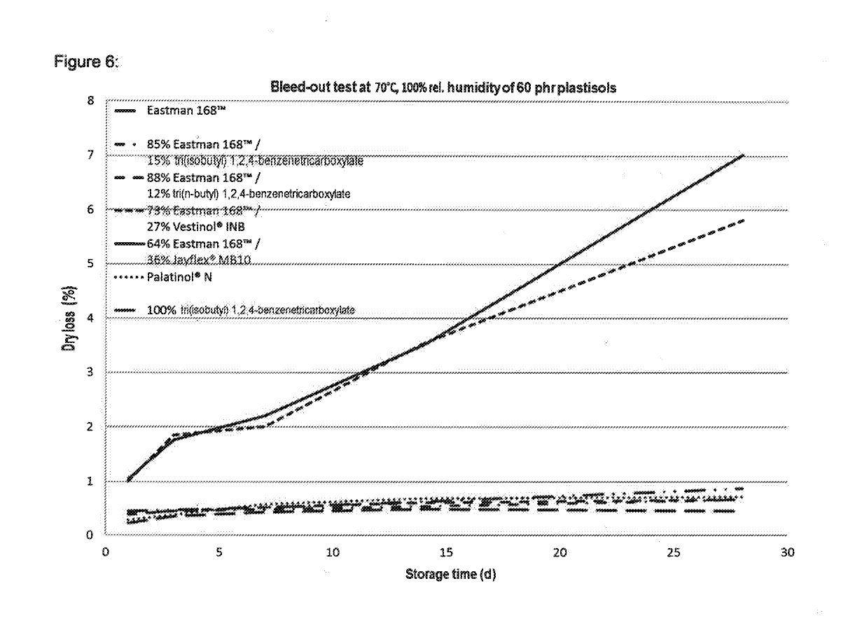

As is very readily apparent from FIG. 6, the exudation characteristics of the plasticizer composition disclosed composed of 12% by weight tri(n-butyl) 1,2,4-benzenetricarboxylate (compound I.3) and 88% by weight Eastman 168™ or 15% tri(isobutyl) 1,2,4-benzenetricarboxylate (compound I.4) and 85% by weight Eastman 168™ are significantly better than the exudation characteristics of the plasticizer compositions composed of 27% by weight Vestinol® INB and 73% by weight Eastman 168™ and also 36% by weight Jayflex® MB 10 and 64% by weight Eastman 168™. The compatibility of the plasticizer composition disclosed is accordingly better than the compatibility of the plasticizer compositions composed of 27% by weight Vestinol® INB and 73% by weight Eastman 168™ and also 36% by weight Jayflex® MB 10 and 64% by weight Eastman 168™.

### III. Comparative Experiments for Volatility of Trialkyl Trimellitates

Trialkyl trimellitates, differing in the number of carbon atoms in their alkyl chains, were investi-gated with respect to their process volatility and film volatility. The process volatility was determined in analogy to II. c), the film volatility determined in analogy to II. e). Plastisols with the following formulations were used for the investigation:

| | phr |
|---|---|
| PVC (mixture of 70 parts by weight homopolymeric | 100 |
| emulsion PVC Solvin ® 367 NC and 30 parts by weight | |
| homopolymeric emulsion PVC Vinnolit ® P 70) | |
| Tri-n-butyl trimellitate (TBTM) | 60 |
| Ba—Zn stabilizer, Reagens SLX/781 | 2 |

| | phr |
|---|---|
| PVC (mixture of 70 parts by weight homopolymeric | 100 |
| emulsion PVC Solvin ® 367 NC and 30 parts by weight | |
| homopolymeric emulsion PVC Vinnolit ® P 70) | |
| Trimethyl trimellitate (TBTM) | 60 |
| Ba—Zn stabilizer, Reagens SLX/781 | 2 |

| | Trimethyl trimellitate | Tributyl trimellitate |
|---|---|---|
| Process volatility [%] | 5.9 | 1.4 |
| Film volatility [%] | 26 | 2 |
| Overall volatility [%] | 32 | 3.4 |

The comparison shows that TMTM has higher volatilities than TBTM.

1.-16. (canceled)

17. A plasticizer composition comprising
(a) at least one compound of the general formula (I), 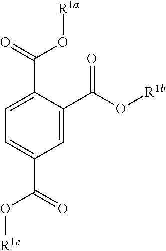
in which
R^{1a}, R^{1b} and R^{1c} are each independently n-propyl, isopropyl, n-butyl, isobutyl, n-pentyl, 2-methylbutyl or 3-methylbutyl, and
(b) at least one compound of the general formula (II), 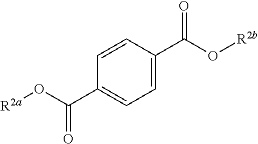
in which
R^{2a} and R^{2b} are each independently C₈-alkyl.

18. The plasticizer composition according to claim 17, wherein in the at least one compound of the general formula (II) present, R^{2a} and R^{2b} are 2-ethylhexyl.

19. The plasticizer composition according to claim 17, wherein the plasticizer composition comprises at least one plasticizer, which is different to the compounds of the general formula (I) and (II).

20. A molding composition comprising at least one polymer and a plasticizer composition according to claim 17.

21. The molding composition according to claim 20, wherein the at least one polymer present is a thermoplastic.

22. The molding composition according to claim 21, wherein the at least one thermoplastic present is selected from the group consisting of polyvinyl chloride (PVC), polyvinyl butyral (PVB), homo- and/or copolymers of vinyl acetate, homo- and/or copolymers of styrene, polyacrylate, thermoplastic polyurethane (TPU) and polysulfide.

23. The molding composition according to claim 20, wherein the at least one polymer present is an elastomer, and the elastomer is natural rubber or synthetic rubber.

24. A plastisol comprising at least one polymer and a plasticizer composition according to claim 17.

25. The plastisol according to claim 24, wherein the at least one polymer present is a thermoplastic.

26. The plastisol according to claim 24, wherein the at least one polymer present is polyvinyl chloride.

27. A process for producing films, wallpaper, seamless hollow bodies, gloves, seals, gaskets, cladding or console covers in vehicles, dolls, game pieces or modelling clays, inflatable toys such as balls or rings, slipper socks, swimming aids, diaper-changing pads, gymnastic balls, exercise mats, seat cushions, vibrators, massage balls or rollers, latex clothing, protective clothing, rain jackets or rubber boots or coatings which comprises utilizing the a plastisol according to claim 20.

28. A molding or film comprising the plasticizer composition according to claim 17.

29. The molding or the film according to claim 28, wherein the molding or the film comes directly into contact with humans or foodstuffs.
